(19) United States
(12) Patent Application Publication
(10) Pub. No.: US 2011/0276909 A1
(43) Pub. Date: Nov. 10, 2011

(54) NUMERICAL VALUE INPUT DEVICE, NUMERICAL VALUE INPUT METHOD, AND PROGRAM

(76) Inventor: Shigeo Nakaishi, Osaka (JP)

(21) Appl. No.: 13/121,456

(22) PCT Filed: Sep. 28, 2009
(86) PCT No.: PCT/JP2009/004908

§ 371 Date: Jun. 9, 2011

(30) Foreign Application Priority Data
Sep. 29, 2008 (JP) 2008-251355

(51) Int. Cl. G06F 3/048

(52) U.S. Cl. 715/764

(57) ABSTRACT

A numerical value input device is provided that makes it possible to suitably input numerical values using a GUI. The device is equipped with: an image data storage unit (11) that stores coordinate plane image data having first and second axes; an image-generating unit (12) that generates point drawing image data of point drawings indicating position on the coordinate plane and drawing image data to a larger scale of larger-scale drawings obtained by magnifying a region including the position of a point drawing; an image display unit (13) that displays coordinate plane image data, point drawing image data and larger-scale drawing image data; an instruction receiving unit (14) that receives instructions specifying the position of a point drawing that is displayed; a numerical value acquisition unit (15) that acquires first and second numerical values of first and second axes corresponding to the position of a point drawing on the coordinate plane; and an output unit (16) that outputs first and second numerical values. This image generating unit (12) generates point drawing image data corresponding to a position specified by the instruction that is received.

### TECHNICAL FIELD

The present invention relates to a numerical value input device and the like for inputting at least one numerical value.

### BACKGROUND ART

Methods of inputting a numerical value using numeric keys or inputting a numerical value using a slider are known (see patent document 1, for example). There are a large number of websites which provide a function for calculating a target value. With the function, at least one argument is input through a numerical value input method of using numeric keys. For example, in one website, a value of BMI (Body Mass Index) indicating the degree of overweight is calculated by entering values of height and body weight of a person, and in another site, basal energy expenditure is calculated by entering the data of height, body weight, and age of a person.

Patent document 1: Japanese Unexamined Patent Application Publication No. 11-345056

### DISCLOSURE OF INVENTION

### Problems to be Solved by the Invention

In the website where the value of BMI is calculated, a method of inputting the numerical value using GUI (Graphic User Interface) is not used. This is because the physical size of an interface such as a monitor used by a user is subject to limitation. The numerical value input method of using the GUI has difficulty in inputting an intended numerical value appropriately, i.e., inputting a numerical value with a higher fineness.

The invention has been developed to overcome the above-described problem, and it is an object of the invention to provide a numerical value input device and the like for inputting an intended numerical value appropriately through the GUI numerical value input method.

### Means for Solving the Problems

To achieve the above object, a numerical value input device of the invention includes an image data storage unit for storing, as coordinate plane image data, image data of a coordinate plane having a first axis and a second axis, an image generation unit for generating, as point graphic image data, image data of a point graphic indicating a position on the coordinate plane, and as expansion graphic image data, image data of an expansion graphic into which a segment being part of the coordinate plane and including the position of the point graphic is expanded, an image display unit for displaying the coordinate plane image data read from the image data storage unit, and the point graphic image data and the expansion graphic image data, generated by the image generation unit, an instruction receiving unit for receiving an instruction specifying the position of the point graphic displayed by the image display unit, a numerical value acquiring unit for acquiring first and second numerical values, the first and second numerical values being respectively first and second axis values corresponding to the position of the point graphic on the coordinate plane, and an output unit for outputting the first and second numerical values acquired by the numerical value acquiring unit. The image generation unit generates the point graphic image data corresponding to the position specified by the instruction received by the instruction receiving unit.

With this arrangement, the numerical value is input by specifying the position of the point graphic. Without using the numerical keys, the numeric value is input using the GUI alone. Since the numerical value is input using the expansion graphic, an intended numerical value is appropriately input with a higher fineness. Two numerical values are input at a time by determining a position on the coordinate plane of one point graphic. As a result, user-friendliness becomes higher than when each numerical value is individually input.

In the numerical value input device of the invention, the coordinate plane image data may be image data of the coordinate plane that is partitioned into a plurality of regions in response to a value given by a predetermined function having as arguments the first and second axis values.

With this arrangement, the range of the value given by the function responsive to an input value is easily learned by referencing which region the point graphic is in.

The numerical value input device of the invention may further include a calculation unit for calculating the value given by the predetermined function using as the arguments the first and second numerical values acquired by the numerical value. The image generation unit may generate, as first numerical value image data, image data of the first numerical value acquired by the numerical value acquiring unit, as second numerical value image data, image data of the second numerical value acquired by the numerical value acquiring unit, and as function calculation result image data, image data of the value given by the function calculated by the calculation unit. The image display unit may display the first numerical value image data, the second numerical value image data, and the function calculation result image data.

This arrangement allows the user to easily know the first and second numerical values in an exact form corresponding to the position of the point graphic and the value given by the function responsive to these values.

A numerical value input device of the invention includes an image data storage unit for storing, as coordinate plane image data, image data of a coordinate plane having a first axis and a second axis, and as coordinate axis image data, image data of a coordinate axis as a third axis, an image generation unit for generating, as point graphic image data, image data of a point graphic indicating a position on the coordinate plane and in the coordinate axis, and as expansion graphic image data, image data of an expansion graphic into which a segment being part of the coordinate plane and including the position of the point graphic is expanded, an image display unit for displaying the coordinate plane image data and the coordinate axis image data, read from the image data storage unit, and the point graphic image data and the expansion graphic image data, generated by the image generation unit, an instruction receiving unit for receiving an instruction specifying the position of the point graphic displayed by the image display unit, a numerical value acquiring unit for acquiring as a third numerical value a third axis value in the third axis corresponding to the position of the point graphic, and first and second numerical values, the first and second numerical values being respectively first and second axis values corresponding to the position of the point graphic on the coordinate plane, and an output unit for outputting the first through third numerical values acquired by the numerical value acquiring unit. The image generation unit generates the point graphic image data corresponding to the position specified by the instruction received by the instruction receiving unit.

With this arrangement, the user may input the numerical value by specifying the position of the point graphic. The user may input the first through third numerical values not using numeric keys but using the GUI alone. Since the numerical value is input using the expansion graphic, an intended numerical value may be input with a higher fineness. The two numerical values may be input at a time by determining the position on the coordinate plane of one point graphic. As a result, user-friendliness becomes higher than when each numerical value is individually input.

In the numerical value input device of the invention, the image display unit may display the coordinate plane image data and the coordinate axis image data such that the first through third axes constitute a coordinate space.

With this arrangement, three arguments may be input in a three-dimensional space.

In the numerical value input device of the invention, the image display unit may display the coordinate plane image data at a position in the third axis corresponding to the third numerical value acquired by the numerical value acquiring unit.

Viewing the display results on the image display unit in this arrangement, the user may intuitively learn the value in the third axis responsive to the coordinate plane image data.

In the numerical value input device of the invention, the coordinate plane image data may be image data of the coordinate plane that is partitioned into a plurality of regions in response to a value given by a predetermined function, the predetermined function having as arguments the first axis value, the second axis value, and the third axis value and with the third numerical value substituted for the third axis value.

With this arrangement, the range of the value given by the function responsive to an input value is easily learned by referencing which region the point graphic is in.

The numerical value input device of the invention may further include a calculation unit for calculating the value given by the predetermined function using as the arguments the first through third numerical values acquired by the numerical value acquiring unit. The image generation unit may generate, as first numerical value image data, image data of the first numerical value acquired by the numerical value acquiring unit, as second numerical value image data, image data of the second numerical value acquired by the numerical value acquiring unit, as third numerical value image data, image data of the third numerical value acquired by the numerical value acquiring unit, and as function calculation result image data, image data of the value given by the function calculated by the calculation unit. The image display unit may display the first numerical value image data, the second numerical value image data, the third numerical value image data, and the function calculation result image data.

This arrangement allows the user to easily learn the first through third numerical values in an exact form corresponding to the position of the point graphic and the value given by the function responsive to these values.

A numerical value input device of the invention includes an image data storage unit for storing, as coordinate axis image data, image data of a coordinate axis, an image generation unit for generating, as point graphic image data, image data of a point graphic indicating a position in the coordinate axis, and as expansion graphic image data, image data of an expansion graphic into which a segment being part of the coordinate axis and including the position of the point graphic is expanded, an image display unit for displaying the coordinate axis image data read from the image data storage unit, and the point graphic image data and the expansion graphic image data, generated by the image generation unit, an instruction receiving unit for receiving an instruction specifying the position of the point graphic displayed by the image display unit, a numerical value acquiring unit for acquiring a numerical value corresponding to the position of the point graphic in the coordinate axis, and an output unit for outputting the numerical value acquired by the numerical value acquiring unit. The image generation unit generates the point graphic image data corresponding to the position specified by the instruction received by the instruction receiving unit.

With this arrangement, the numerical value is input by specifying the position of the point graphic. The numeric value is input not using the numerical keys but using the GUI alone. Since the numerical value is input using the expansion graphic, an intended numerical value is appropriately input with a higher fineness.

In the numerical value input device of the invention, the coordinate axis image data may be image data of the coordinate axis that is partitioned into a plurality of regions in response to a value given by a predetermined function having as an argument the value in the coordinate axis.

With this arrangement, the range of the value given by the function responsive to an input value is easily learned by referencing which region the point graphic is in.

The numerical value input device of the invention may further include a calculation unit for calculating the value given by the predetermined function using as the argument the numerical value acquired by the numerical value acquiring unit. The image generation unit may generate, as numerical value image data, image data of the numerical value acquired by the numerical value acquiring unit and as function calculation result image data, image data of the value given by the function calculated by the calculation unit. The image display unit may display the numerical value image data, and the function calculation result image data.

This arrangement allows the user to easily learn the numerical value in an exact form corresponding to the position of the point graphic and the value given by the function responsive to the numerical value.

In the numerical value input device of the invention, the image generation unit may generate the expansion graphic image data with a display position thereof changed in response to the position of the point graphic.

In the numerical value input device of the invention, the image generation unit may not change the position of the expansion graphic if the position of the point graphic is within an expansion area of the expansion graphic.

A numerical value input device of the invention includes an image data storage unit for storing, as coordinate axis image data, image data of first through N-th (N being an integer of 2 or larger) coordinate axes, an image generation unit for generating, as point graphic image data, image data of a point graphic indicating a position in each of the coordinate axes, and as expansion graphic image data, image data of an expansion graphic into which a segment being part of each of the coordinate axes and including the position of the point graphic is expanded, an image display unit for displaying the coordinate axis image data read from the image data storage unit, and the point graphic image data and the expansion graphic image data, generated by the image generation unit, an instruction receiving unit for receiving an instruction specifying the position of the point graphic displayed by the image display unit, a numerical value acquiring unit for acquiring first through N-th numerical values, the first through N-th numerical values being first through N-th axis values corresponding to the position of the point graphic, and an output unit for outputting the first through N-th numerical values acquired by the numerical value acquiring unit. The image generation unit generates the point graphic image data corresponding to the position specified by the instruction received by the instruction receiving unit.

With this arrangement, the user may input the numerical value by specifying the position of the point graphic. The user may input the first through third numerical values not using the numeric keys but using the GUI alone. Since the numerical value is input using the expansion graphic, an intended numerical value may be input with a higher fineness. Since the expansion graphics are displayed on a per coordinate axis basis, a value with a higher fineness corresponding to the position of the point graphic in each coordinate axis is verified.

In the numerical value input device of the invention, the image generation unit may generate the point graphic image data and the expansion graphic image data on a per coordinate axis basis.

With this arrangement, the user may input the numerical value using the point graphic on a per coordinate axis basis.

In the numerical value input device of the invention, the image data storage unit may store, as coordinate space image data, image data of an N-dimensional coordinate space including coordinate axis image data of the first through N-th axes, and the image display unit may display the coordinate space image data read from the image data storage unit.

With this arrangement, the user may input the values of N arguments in the N-dimensional coordinate space.

In the numerical value input device of the invention, the coordinate space image data may be image data of the coordinate space that is partitioned into a plurality of regions in response to a value given by a predetermined function having as arguments the first through N-th numerical values.

With this arrangement, the range of the value given by the function responsive to an input value is easily learned by referencing which region the point graphic is in.

The numerical value input device of the invention may further include a calculation unit for calculating the value given by the predetermined function using as the arguments the first through N-th numerical values acquired by the numerical value acquiring unit. The image generation unit may generate, as first through N-th numerical value image data, image data of the first through N-th numerical values acquired by the numerical value acquiring unit and as function calculation result image data, image data of the value given by the function calculated by the calculation unit. The image display unit may display the first through N-th numerical value image data, and the function calculation result image data.

This arrangement allows the user to easily learn the numerical value in an exact form corresponding to the position of the point graphic and the value given by the function responsive to the value.

In the numerical value input device of the invention, the image generation unit may generate the expansion graphic image data with a display position thereof changed in response to the position of the point graphic.

In the numerical value input device of the invention, the image generation unit may not change the position of the expansion graphic if the position of the point graphic in each of the coordinate axes is within an expansion area of the expansion graphic.

### Adavantages

The numerical value input device and the like of the invention inputs the numerical value by specifying the position of the point graphic. Without using the numeric key, the user may enter the numerical value using the GUI alone. Since the numerical value can be entered using the expansion graphic, the user may enter an intended numerical value with a high fineness.

### BRIEF DESCRIPTION OF THE DRAWINGS

FIG. 1 is a block diagram illustrating a configuration of a numerical value input device of an embodiment 1 of the invention.

FIG. 2 is a flowchart illustrating an operation of the numerical value input device of the embodiment.

FIG. 3 is a flowchart illustrating an operation of the numerical value input device of the embodiment.

FIG. 4 is a flowchart illustrating an operation of the numerical value input device of the embodiment.

FIG. 5 illustrates an example of a screen.

FIG. 6 illustrates an example of the screen.

FIG. 7 illustrates a movement of an expansion graphic in the embodiment.

FIG. 8 illustrates a movement of the expansion graphic in the embodiment.

FIG. 9 is a flowchart illustrating an operation of a numerical value input device of the embodiment.

FIG. 10 illustrates an example of a screen in the embodiment.

FIG. 11 illustrates an example of the screen in the embodiment.

FIG. 12 illustrates an example of the screen in the embodiment.

FIG. 13 is a flowchart illustrating an operation of a numerical value input device of an embodiment 2 of the invention.

FIG. 14 is a flowchart illustrating the operation of the numerical value input device of the embodiment.

FIG. 15 illustrates an example of a screen in the embodiment.

FIG. 16 illustrates an example of the screen in the embodiment.

FIG. 17 illustrates an example of the screen in the embodiment.

FIG. 18 illustrates an example of the screen in the embodiment.

FIG. 19 illustrates an example of the screen in the embodiment.

FIG. 20 illustrates an example of a screen of an embodiment 3 of the invention.

FIG. 21 illustrates an example of the screen of the embodiment.

FIG. 22 illustrates an example of the screen of the embodiment.

FIG. 23 illustrates an example of the screen of the embodiment.

FIG. 24 illustrates an example of the screen of the embodiment.

FIG. 25 is a diagrammatic external view of a computer system in each of the embodiments.

FIG. 26 illustrates a configuration of the computer system in each of the embodiments.

### EMBODIMENTS OF THE INVENTION

Embodiments of a numerical value input device of the invention are described below. In the discussion of the embodiments, elements or steps identified with the same reference symbols are equal to or correspond to each other, and the discussion thereof is not repeated.

### Embodiment 1

The numerical value input device of embodiment 1 of the invention is described with reference to the drawings. The numerical value input device of the embodiment receives two arguments.

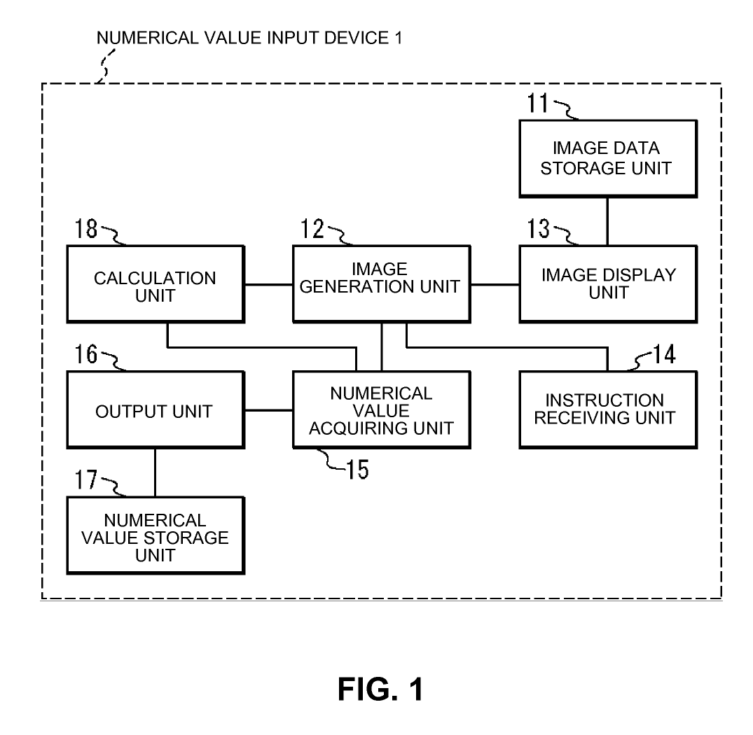

FIG. 1 is a block diagram illustrating a configuration of the numerical value input device 1 of the embodiment. The numerical value input device 1 of the embodiment includes image data storage unit 11, image generation unit 12, image display unit 13, instruction receiving unit 14, numerical value acquiring unit 15, output unit 16, numerical value storage unit 17, and calculation unit 18.

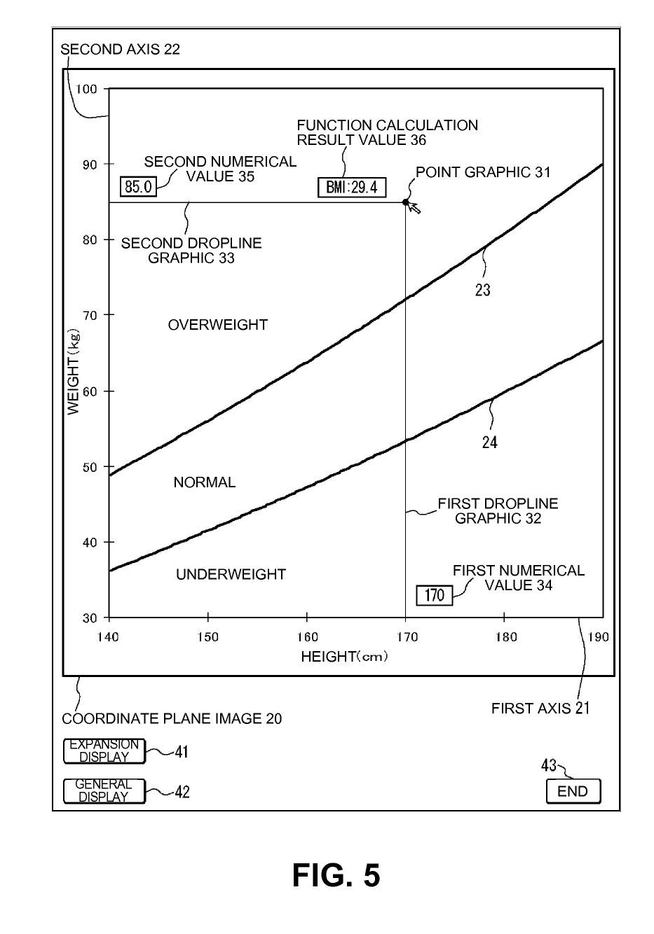

The image data storage unit 11 stores coordinate plane image data. The coordinate plane image data is image data of a coordinate plane having a first axis 21 and a second axis 22 as illustrated in FIG. 5. The numerical value input device 1 of the embodiment receives a first argument corresponding to the first axis 21 and a second argument corresponding to the second axis 22. Referring to FIG. 5, the first and second axes 21 and 22 are linear lines in the coordinate plane, and are perpendicular to each other. The first and second axes 21 and 22 may not be necessarily perpendicular to each other. For example, the coordinate plane may be an oblique coordinate plane. Any coordinate plane image data is acceptable as long as the data can serve to display an image on a coordinate plane in any form. For example, the coordinate plane image data may be an image itself such as raster data. The coordinate plane image data may be vector data that can be rasterized into an image.

In the embodiment, the numerical value input device 1 inputs height and body weight of a person for BMI value calculation.

The first axis 21 is thus an axis representing the height (cm) of the person as an argument. The second axis 22 is an axis representing the body weight (kg) of the person as an argument. The second axis 22 is perpendicular to the first axis 21. The horizontal axis represents height, and the vertical axis represents body weight in FIG. 5, but the setting may be reversed. Information indicating the argument represented by the first axis 21, for example, a character string “height,” may be displayed close to the axis as illustrated in FIG. 5. The first axis 21 may be marked with gradations and numerical values as illustrated in FIG. 5. The same is true of the second axis 22. Information indicating the argument represented by the second axis 22, for example, a character string “body weight,” may be displayed close to the axis as illustrated in FIG. 5. The second axis 22 may be marked with gradations and numerical values.

A first boundary line 23 illustrates a parabolic curve that indicates the relationship of height and body weight with BMI being a first value. A second region boundary line 24 illustrates a parabolic curve that indicates the relationship of height and body weight with BMI being a second value. BMI has already been described and is defined by the following equation:

BMI=body weight (kg)/{height (m)}²

As seen from this equation, a curve with BMI being a constant value is a parabolic curve. According to the embodiment, the first value is “25”, and the second value is “18.5”. These values may be any other appropriate values. The coordinate plane of the coordinate plane image data may be partitioned into a plurality of regions in accordance with the value given by a predetermined function having a value in the first axis 21 and a value in the second axis 22 serving as arguments (a function of BMI in the embodiment). The partitioning of the coordinate plane in accordance with the value given by the predetermined function means that the coordinate plane is partitioned in accordance with the range of the values given by the predetermined function as illustrated in FIG. 5.

A coordinate plane image 20 of FIG. 5 corresponding to the coordinate plane image data is partitioned into three regions by first and second region boundary lines 23 and 24. More specifically, the coordinate plane is partitioned into a region delineated by the second axis 22, and the first region boundary line 23 (that region is referred to as a “first region”), a region delineated by the second axis 22, the first region boundary line 23, and the second region boundary line (that region is referred to as a “second region”), and a region delineated by the first axis 21, the second axis 22, and the second boundary line 24 (that region is referred to as a “third region”). The first region boundary line 23 is a region boundary line along which BMI is 25, and the second region boundary line 24 is a region boundary line along which BMI is 18.5. The first region is a region where BMI is higher than 25. The second region is a region where BMI is higher than 18.5 but lower than 25. The third region is a region where BMI is lower than 18.5. The first through third regions may be colored with different colors, or hatched in different hatching modes such that the user may visibly easily identify each region.

The first region having BMI higher than 25 is a region of “overweight”. The second region having BMI higher than 18.5 but lower than 25 is a region of “normal”. The third region having BMI lower than 18.5 is a region of “underweight”. As illustrated in FIG. 5, words “overweight”, “normal”, and “underweight” featuring the respective regions may be displayed on the respective regions.

The process of storing the coordinate plane image data on the image data storage unit 11 is not limited to any process. For example, the coordinate plane image data may be stored on the image data storage unit 11 via a recording medium. The coordinate plane image data may be transmitted via a communication line and the like and then stored on the image data storage unit 11. The coordinate plane image data may be input via an input device and then stored on the image data storage unit 11. The storage of the coordinate plane image data on the image data storage unit 11 may be performed on a temporary basis, for example, on a RAM, or may be performed on a long-term basis. The image data storage unit 11 may be a predetermined recording medium (such as a semiconductor memory device, a magnetic disk, or an optical disk).

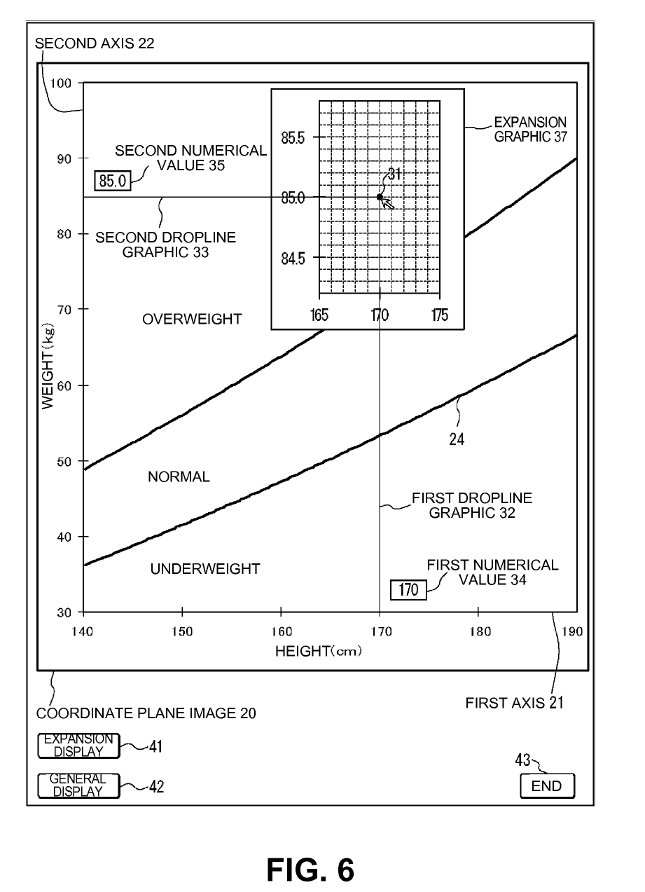

The image generation unit 12 generates point graphic image data, expansion graphic image data, first numerical value image data, second numerical value image data, function calculation result image data, first dropline graphic image data, and second dropline graphic image data. These pieces of image data are described with reference to FIGS. 5 and 6.

The point graphic image data is image data of a point graphic 31. The point graphic 31 is a graphic denoting a position on the coordinate plane image 20 represented by the coordinate plane image data. By specifying a position on the point graphic 31, both the value in the first axis 21 (height) and the value in the second axis 22 (body weight) corresponding to the point graphic 31 are specified at a time. The point graphic 31 is displayed on the coordinate plane image 20. Whether a subject is overweight or not is determined by determining which region the point graphic 31 is located on. As illustrated in FIG. 5, the point graphic 31 may be a dot (or a circle), or may be another graphic such as a cross, a triangle, or a square.

If the instruction receiving unit 14 to be discussed later receives an instruction specifying the position of the point graphic 31, the image generation unit 12 generates the point graphic image data corresponding to the position specified by the instruction. More specifically, the image generation unit 12 generates the point graphic image data such that the point graphic 31 is moved to the position specified by the instruction received by the instruction receiving unit 14 to be discussed later. If the instruction receiving unit 14 to be discussed later thus receives the instruction specifying the position of the point graphic 31, the point graphic image data corresponding to the heretofore displayed point graphic 31 may be erased, and point graphic image data to a newly instructed position may be generated.

The point graphic image data is the image data of the point graphic. The point graphic image data may be any type of image data as long as the data finally serves to display a point graphic. For example, the point graphic image data may be an image itself such as raster data, or may be vector data that can be rasterized into an image. The point graphic image data may be generated on the coordinate plane image 20 represented by the coordinate plane image data, or may be generated separately from the coordinate plane image 20. In the latter case, the point graphic image data preferably includes information representing a display position on the coordinate plane image 20. The point graphic image data may be temporarily stored on the unillustrated recording medium or may be temporarily stored on the image data storage unit 11. The content described in this paragraph holds true of other graphic data generated by the image generation unit 12.

The expansion graphic image data is image data of an expansion graphic 37. The expansion graphic 37 is part of the coordinate plane, and an expansion area including the position of the point graphic 31. With the expansion graphic 37 displayed on the coordinate plane image 20, the user can input a numerical value with a higher fineness than when the user directly inputs a numerical value on the coordinate plane. As illustrated in FIG. 6, a numerical value is displayed with a higher fineness in each of the axes on the expansion graphic 37 corresponding to the first and second axes 21 and 22 than in the first and second axes 21 and 22. Gridlines of horizontal and vertical broken lines are preferably displayed in the expansion graphic 37 of FIG. 6. The gridlines may not be displayed. The expansion graphic 37 may or may not be displayed at the position of the point graphic 31 (right over the position of the point graphic 31). In the latter case, the expansion graphic 37 may be displayed at a predetermined position (not necessarily on the coordinate plane image 20).

If the expansion graphic 37 is displayed on the coordinate plane, the point graphic 31 is displayed on the expansion graphic 37. To this end, the image generation unit 12 may generate the point graphic image data such that the point graphic 31 is placed at the most proximal position to a user.

The first numerical value image data is image data of the first numerical value. The first numerical value is the value in the first axis 21 corresponding to the point graphic 31, acquired by the numerical value acquiring unit 15. With the first numerical value 34 displayed, the user can learn the value in the first axis 21 corresponding to the point graphic 31. The first numerical value 34 may or may not be displayed in the vicinity of the position in the first axis 21 corresponding to the first numerical value. In the former case, a display position of the first numerical value 34 may be moved along with the movement of the point graphic 31. In the latter case, the first numerical value 34 may be continuously displayed at a predetermined position. The first numerical value image data is image data typically representing a numerical value in text.

The second numerical value image data is image data of the second numerical value. The second numerical value 35 is the value in the second axis 22 corresponding to the point graphic 31 acquired by the numerical value acquiring unit 15. With the second numerical value 35 displayed, the user can learn the value in the second axis 22 corresponding to the point graphic 31. The second numerical value 35 is identical to the first numerical value 34 described above except that the two numerical values are different in value, and the detailed discussion thereof is thus omitted herein.

The calculation result image data is image data of the value given by the predetermined function calculated by the calculation unit 18 to be discussed later. With the function calculation result value 36 displayed, the user can learn the value given by the function responsive to the values in the first and second axes 21 and 22 corresponding to the point graphic 31. More specifically, the user can learn the value of BMI corresponding to the height and body weight input via the point graphic 31. The position where the function calculation result value 36 is displayed is not limited to any particular display position. For example, the function calculation result value 36 may be displayed in the vicinity of the point graphic 31 as illustrated in FIG. 5 or may be displayed at a predetermined position. The calculation result image data is typically the image data representing a numerical value in text.

The first dropline graphic image data is image data of a first dropline graphic 32. The first dropline graphic 32 is a graphic of a dropline that is drawn from the point graphic 31 to the position in the first axis 21 corresponding to the point graphic 31 (line of fall). The value in the first axis 21 corresponding to the point graphic 31 is easily learned by the intersection of the first dropline graphic 32 and the first axis 21.

The second dropline graphic image data is image data of a second dropline graphic 33. The second dropline graphic 33 is a graphic of a dropline that is drawn from the point graphic 31 to the position in the second axis 22 corresponding to the point graphic 31. The value in the second axis 22 corresponding to the point graphic 31 is easily learned by the intersection of the second dropline graphic 33 and the second axis 22.

The first and second dropline graphics 32 and 33 are typically drawn from the point graphic 31 in parallel with the first and second axes 21 and 22. The first and second dropline graphics 32 and 33 are not limited to those determined in this method as long as the values in the first and second axes 21 and 22 corresponding to the point graphic 31 are determined. The first and second dropline graphics 32 and 33 are typically linear graphics.

The image generation unit 12 may generate the point graphic image data, the expansion graphic image data, and the like based on source image data pre-stored on the unillustrated recording medium. The source image data may be image data of a graphic used as a point graphic (such as a circular graphic), may be image data of a frame, a gridline, and the like used when the expansion graphic image data is generated, or may be image data of a frame used when the first and second numerical value image data and the calculation result image data are generated. The source image data may be other image data.

The image display unit 13 displays a variety of pieces of image data including the coordinate plane image data read from the image data storage unit 11 and the point graphic image data generated by the image generation unit 12. The image display unit 13 is designed to provide a display output that is to be finally displayed as an image of the coordinate plane image data and the like. For example, the image display unit 13 may be a transmitter unit transmitting the image data and the like to a display device (such as a CRT or a liquid-crystal display). Alternatively, the image display unit 13 may or may not include a display device displaying the image data. The image display unit 13 may be implemented based on hardware, or based on software such as a driver for driving a predetermined display device.

The image generation unit 12 may successively store the generated image data on the recording medium from which the image display unit 13 to be discussed later reads the image data. In such a case, the coordinate plane image data may be pre-stored on the recording medium, and the image display unit 13 may display the image data by simply reading and displaying the image data from the recording medium. In such a case, the recording medium may be the image data storage unit 11.

The instruction receiving unit 14 receives an instruction specifying a position of the point graphic displayed by the image display unit 13. For example, the instruction receiving unit 14 may receive the instruction specifying the position of the point graphic 31 on the coordinate plane via a mouse, a trackpad, a touchpanel, an arrow key, and the like. The instruction specifying the position of the point graphic 31 may be an instruction to determine the position of the point graphic 31 (such as clicking on the position of the point graphic 31). Alternatively, the instruction specifying the point graphic 31 may be an instruction to move the position of the point graphic 31 (such as dragging the point graphic 31 being displayed).

The instruction receiving unit 14 may receive an instruction as to whether to display the expansion graphic image data. For example, the instruction receiving unit 14 may receive an instruction to display the expansion graphic image data or may receive an instruction not to display the expansion graphic image data. The image generation unit 12 may or may not generate the expansion graphic image data depending on the presence or absence of the instruction to display the expansion graphic image data. Alternatively, the image display unit 13 may or may not display the expansion graphic image data. As long as the expansion graphic image data is displayed in response to the presence or absence of the instruction to display the expansion graphic image data, the process of displaying the expansion graphic image data is not important.

The instruction receiving unit 14 may receive information input on an input device (such as a keyboard, a mouse, or a touchpanel), for example. Alternatively, the instruction receiving unit 14 may receive information transmitted via a wired or wireless communication line. The instruction receiving unit 14 may or may not include a device for reception (such as a modem or a network card). The instruction receiving unit 14 may be implemented based on hardware, or based on software such as a driver for driving a predetermined device.

The numerical value acquiring unit 15 acquires as a first numerical value a value in the first axis 21 and as a second numerical value a value in the second axis 22, corresponding to the position of the point graphic 31 on the coordinate plane. The value in the axis corresponding to the position of the point graphic 31 may be determined as below. In the case of the first axis 21, a line is drawn in parallel with the second axis 22 from the point graphic 31 and the value in the axis corresponding to the point graphic 31 is the value at the intersection of the line and the first axis 21. Similarly in the case of the second axis 22, a line is drawn in parallel with the first axis 21 from the point graphic 31 and the value in the axis corresponding to the point graphic 31 is the value at the intersection of the line and the second axis 22. The numerical value acquiring unit 15 may acquire the first and second numerical values, for example, by detecting the position of the point graphic 31 on a display screen and by converting the position into a position on the coordinate plane. In such a case, the numerical value acquiring unit 15 may or may not change the method of converting the position of the point graphic 31 on the display screen into the first and second numerical values depending on whether the point graphic 31 is present on the expansion graphic 37 or the coordinate plane. If the point graphic 31 is present on the expansion graphic 37, the numerical value acquiring unit 15 may acquire the first and second numerical values using coordinate values in the expansion graphic 37. If the point graphic 31 is present on the coordinate plane, the numerical value acquiring unit 15 may acquire the first and second numerical values using coordinates in the coordinate plane.

The output unit 16 may output the first and second numerical values acquired by the numerical value acquiring unit 15. The output may be displayed on a display device (such as a CRT display, or a liquid-crystal display), may be transmitted to a predetermined device via a communication line, may be printed on a printer, may be output in audio to a loudspeaker, may be stored on a recording medium, or may be transferred to another element. According to the embodiment, the output unit 16 transfers the first and second numerical values to the numerical value storage unit 17. The output unit 16 may or may not include a device for outputting (such as a display device, or a printer). The output unit 16 may be implemented based on hardware, or based on software such as a driver for driving a predetermined device.

The numerical value storage unit 17 stores the first and second numerical values output by the output unit 16 as described above. The storage of the first and second numerical values on the numerical value storage unit 17 may be performed on a temporary basis, for example, on a RAM, or may be performed on a long-term basis. The numerical value storage unit 17 may be a predetermined recording medium (such as a semiconductor memory device, a magnetic disk, or an optical disk).

The calculation unit 18 calculates a value given by the predetermined function using as arguments the first and second numerical values acquired by the numerical value acquiring unit 15. In the embodiment, the predetermined function is preferably the predetermined function as the function used when the coordinate plane is partitioned into a plurality of regions. The predetermined function may not be the same predetermined function as the function used when the coordinate plane is partitioned into a plurality of regions. The former case where the predetermined function is an equation for BMI calculation is discussed in the embodiment. The predetermined function is stored on the unillustrated recording medium. The calculation unit 18 may read the predetermined function and then calculate the value given by the predetermined function in response to the first and second numerical values.

The image data storage unit 11 and the numerical value storage unit 17 may be the same recording medium or may be different recording media. In the former case, an area of the medium storing the coordinate plane image data serves as the image data storage unit 11, and an area of the medium storing the first and second numerical values serves as the numerical value storage unit 17.

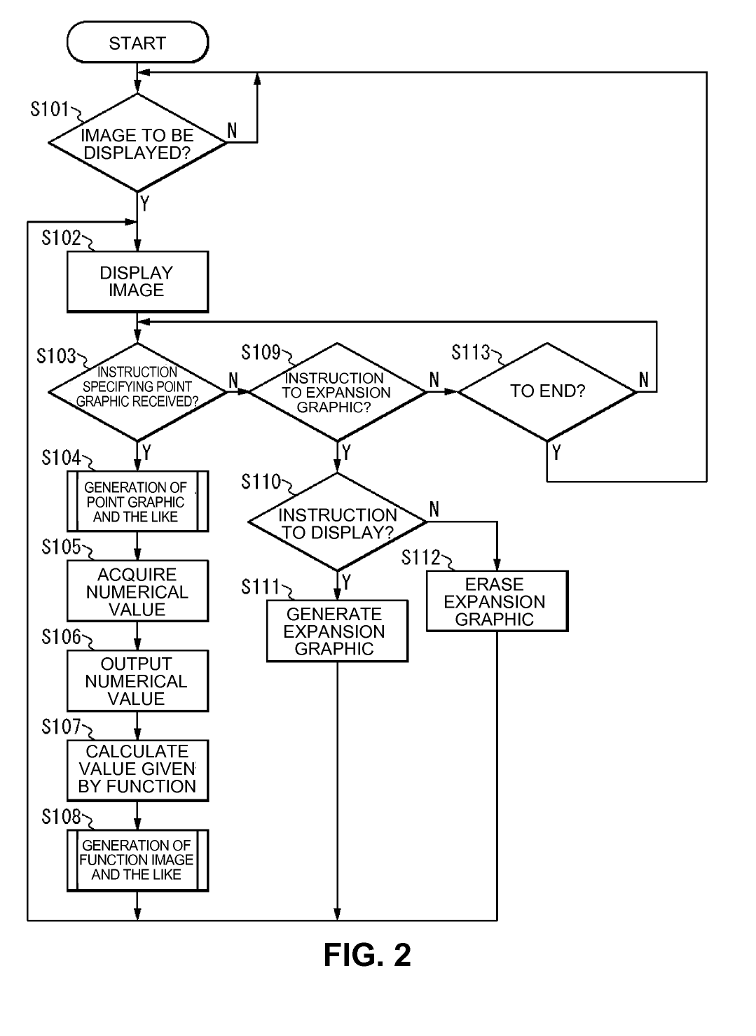

Operation of the numerical value input device 1 of the embodiment is described with reference to a flowchart of FIG. 2.

Step S101 The image display unit 13 determines whether to display the coordinate plane image data and the like. If the coordinate plane image data is to be displayed, processing proceeds to step S102. If the coordinate plane image data is not to be displayed, the operation in step S101 is repeated until it is determined that the coordinate plane image data is to be displayed. The image display unit 13 may determine that the coordinate plane image data is to be displayed if an instruction to display the coordinate plane image data and the like has been received. At another timing, the image display unit 13 may determine that the coordinate plane image data is to be displayed.

Step S102 The image display unit 13 displays the coordinate plane image data read from the image data storage unit 11 and the image data generated by the image generation unit 12. If the coordinate plane image data and the like is displayed for the first time, the image display unit 13 may or may not display the point graphic 31 at a predetermined position, and the first and second dropline graphics 32 and 33, the first and second numerical values 34 and 35, the function calculation result value 36, and the like corresponding to the position of the point graphic 31.

Step S103 The instruction receiving unit 14 determines whether the instruction specifying the position of the point graphic 31 has been received. If the instruction has been received, processing proceeds to step S104. If the instruction has not been received, processing proceeds to S109.

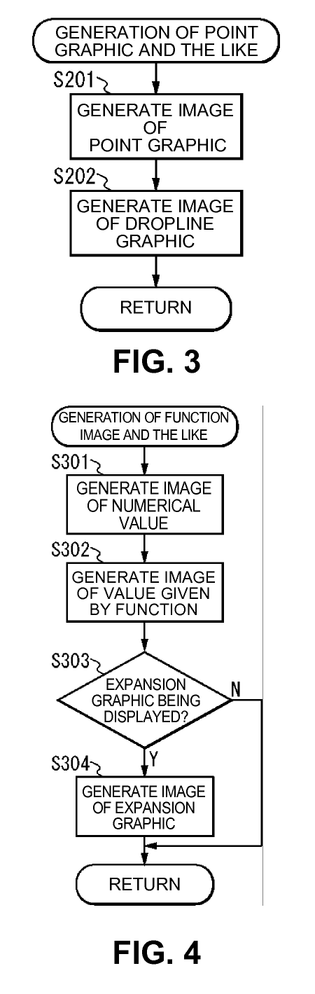

Step S104 The image generation unit 12 generates the image data of the point graphic in response to the received instruction. This process is described in detail below with reference to a flowchart of FIG. 3.

Step S105 The numerical value acquiring unit 15 acquires the first and second numerical values corresponding to the position of the point graphic 31. For example, the numerical value acquiring unit 15 acquires the coordinate values in a screen coordinate system corresponding to the position of the point graphic 31. The coordinate values may be acquired by an operating system (OS). The screen coordinate system refer to a coordinate system in which the top left corner of the display screen displaying the coordinate plane image 20 and the like serves as the origin, from which the X axis extends rightward, and from which the Y axis extends downward. A client coordinate system may be set, for example. In the client coordinate system, the top left corner of the coordinate system of FIG. 5, i.e., the point (height, body weight)=(140, 100) serves as the origin, from which the X axis extends rightward, and from which the Y axis extends downward. The client coordinate system covers a rectangular area having points (height, body weight)=(140, 100), (140, 30), (190, 30), and (190, 100) serving as corners. The bottom left corner of the area of the client coordinate system is set at (height, body weight)=(140, 30), and the top right corner of the area of the client coordinate system is set at (height, body weight)=(190, 100). The numerical value acquiring unit 15 then converts the acquired coordinate values of the screen coordinate system into the coordinate values of the client coordinate system. Finally, the numerical value acquiring unit 15 acquires the first numerical value (the value of the height), and the second numerical value (the value of the body weight) by converting the client coordinate system into the coordinate values of (height, body weight). The conversion of the coordinate value of the screen coordinate system into the coordinate value of the client coordinate system is known, and the detailed discussion thereof is omitted here. The conversion of the coordinate value of the client coordinate system into the coordinate value of the first and second axes 21 and 22 is performed using a simple coordinates conversion technique. For example, the coordinate system of (height, body weight) is set up as illustrated in FIG. 5. Let A represent a maximum value in the X axis of the client coordinate system, and B represent a maximum value in the Y axis of the client coordinate system. If the coordinate values of the client coordinate system are (X, Y), (height, body weight) is represented by the following equation:

(height, body weight)=(140+50×X/A, 100−70×Y/B)

Step S106 The output unit 16 outputs the first and second numerical values acquired by the numerical value acquiring unit 15. In other words, the output unit 16 stores the first and second numerical values on the numerical value storage unit 17.

Step S107 The calculation unit 18 calculates the value given by the predetermined function based on the first and second numerical values acquired by the numerical value acquiring unit 15.

Step S108 The image generation unit 12 generates image data of the function calculation result value 36. The process in this step is described in detail with reference to a flowchart of FIG. 4. Processing returns to step S102.

Step S109 The instruction receiving unit 14 determines whether an instruction to display the expansion graphic 37 or an instruction not to display the expansion graphic 37 has been received. If the instruction to display the expansion graphic 37 has been received, processing proceeds to step S110. If the instruction to display the expansion graphic 37 has not been received, processing proceeds to step S113.

Step S110 The image generation unit 12 determines whether the instruction received by the instruction receiving unit 14 about the expansion graphic 37 is an instruction to display the expansion graphic 37. If the received instruction is the instruction to display the expansion graphic 37, processing proceeds to step S111. If not, i.e., if the received instruction is an instruction to erase the expansion graphic 37, processing proceeds to step S112.

Step S111 The image generation unit 12 generates image data of an expansion graphic 37 newly. Processing returns to step S102. As a result, the expansion graphic 37 is displayed.

Step S112 The image generation unit 12 erases the heretofore displayed expansion graphic 37. Processing returns to step S102. As a result, the heretofore displayed expansion graphic 37 is erased.

Step S113 The image display unit 13 determines whether to quit displaying the coordinate plane image data and the like. To quit displaying the coordinate plane image data and the like, processing returns to step S101. If not, processing returns to step S103. Upon receiving an instruction to quit displaying the coordinate plane image data and the like, the image display unit 13 determines that the displaying of the coordinate plane image data and the like is to quit. Alternatively, the image display unit 13 may determine that the displaying of the coordinate plane image data and the like is to quit if a predetermined period of time has elapsed since the image data was displayed last.

In the flowchart of FIG. 2, the process quits in response to power off or a process end interruption.

FIG. 3 is a flowchart illustrating in detail the generation process of the point graphic and the like (step S104) in the flowchart of FIG. 2.

Step S201 The image generation unit 12 generates the point graphic image data in response to the instruction specifying the position of the point graphic 31 received by the instruction receiving unit 14. For example, if the received instruction is an instruction to move the point graphic 31, the image generation unit 12 deletes the point graphic image data at that point of time, and generates point graphic image data corresponding to the position of a movement destination. If the received instruction is an instruction to newly display a point graphic 31, the image generation unit 12 generates the point graphic image data at the specified position. The generation of the point graphic image data may be performed using the point graphic 31 pre-stored on the unillustrated recording medium. The generation of the point graphic image data may be a process of determining a display position of the point graphic 31.

Step S202 The image generation unit 12 generates, as the first and second dropline graphic image data, the image data of the first and second dropline graphics 32 and 33 respectively extending to the first and second axes 21 and 22 from the point graphic 31. For example, the abscissa value corresponding to the point graphic 31 on the screen coordinate system is A, and the ordinate value corresponding to the point graphic 31 on the screen coordinate system is B, the first axis 21 is on a line having C in the Y axis of the screen coordinate system, and the second axis 22 is on a line having D in the X axis of the screen coordinate system. The image generation unit 12 may generate the first dropline graphic image data for displaying the first dropline graphic 32 as a line segment from (A, B) to (A, C). Similarly, the image generation unit 12 may generate the second dropline graphic image data for displaying the second dropline graphic 33 as a line segment from (A, B) to (D, B). Client coordinate system may be used instead of the screen coordinate system. The discussion of the flowchart of FIG. 2 follows.

FIG. 4 is a flowchart illustrating in detail the generation process of the function image and the like (step S108) in the flowchart of FIG. 2.

Step S301 The image generation unit 12 generates the first numerical value image data and the second numerical value image data based on the first and second numerical values acquired by the numerical value acquiring unit 15. For example, the image generation unit 12 may generate the first and second numerical value image data by reading, as source image data, image data of a graphic such as a frame stored on the unillustrated recording medium, and substituting the first numerical value and the second numerical value in text in the image data. The display positions of the first and second numerical values 34 and 35 may be set to be respectively close to the first value in the first axis 21 and the second value in the second axis 22. In this case, the display positions of the first and second numerical values 34 and 35 may be determined by converting values from the coordinate system of the first and second axes 21 and 22 into values in the client coordinate system.

Step S302 The image generation unit 12 generates the function calculation result image data based on the value given by the function calculated by the calculation unit 18. For example, the image generation unit 12 may generate the function calculation result image data by reading, as source image data, image data of a graphic such as a frame stored on the unillustrated recording medium, and substituting the value given by the function in text in the image data. The display position of the function calculation result value 36 may be set to be close to the point graphic 31.

Step S303 The image generation unit 12 determines whether the expansion graphic 37 is being displayed. More specifically, the image generation unit 12 determines whether the expansion graphic image data is included in an image to be displayed by the image display unit 13. If the expansion graphic 37 is being displayed, processing proceeds to step S304. If the expansion graphic 37 is not being displayed, processing returns to the flowchart of FIG. 2.

Step S304 The image generation unit 12 generates as the expansion graphic image data the image data of the expansion graphic 37. For example, the image generation unit 12 may read, as source image data, image data of a graphic such as a frame stored on the unillustrated recording medium, and generate image data of broken gridlines or coordinate values such that a predetermined position of the source image data (such as the center point of the source image data) becomes coordinate values of the point graphic 31 (coordinate values in the first and second axes 21 and 22). More specifically, the image generation unit 12 reads the image data of the graphic such as a frame, and arranges the image data of the broken gridlines within the frame in response to the coordinate values of the point graphic 31. If the two coordinate values of the point graphic 31 are both integers in the arrangement, the image generation unit 12 arranges the image data of the broken gridlines such that the position of the point graphic 31 is at an intersection of the gridlines. If one of the two coordinate values of the point graphic 31 is not an integer, the image generation unit 12 arranges the image data of the broken gridlines such that the position of the point graphic 31 is shifted by the corresponding fraction to an integer. For example, the fraction of the coordinate value in the first axis 21 below the decimal point may be A, and the gridlines may be arranged by integer in the first axis 21. The image generation unit 12 may set the gridlines such that the intersections of the gridlines may be shifted by A/10 of a unit of the gridlines in the first axis 21 respectively toward the smaller integers in the first axis 21. Using the length of one unit of the gridlines and the coordinate values of the point graphic 31, the gridlines included in the expansion graphic image data are identified every integer, every “5,” or every “10,” corresponding to the values in the first axis 21. The image generation unit 12 may arrange the image data of the coordinate value in text with the identified gridline mapped thereto. The coordinate values of the point graphic 31 are learned by referencing the first and second numerical values acquired by the numerical value acquiring unit 15. The image generation unit 12 may determine the display position of the expansion graphic 37 such that the location of the point graphic 31 on the expansion graphic 37 matches the location of the point graphic 31 on the coordinate plane constituted of the first and second axes 21 and 22. The discussion of the flowchart of FIG. 2 follows.

The generation of the expansion graphic image data in the above-described step S111 is performed in the same manner as described with reference to step S304.

In the flowchart of FIG. 4, the process order of steps S301, step S302, and steps S303 and S304 is not important.

A specific example of the operation of the numerical value input device 1 of the embodiment is described below. In this specific example, the image display unit 13 displays each of the data on a display thereof.

The user may now operate the mouse or the keyboard to input on the numerical value input device 1 an instruction to output the coordinate plane image 20. The image display unit 13 determines that it is time to display the image data (step S101). The image display unit 13 reads the coordinate plane image data from the image data storage unit 11 and outputs the read coordinate plane image data to the display (step S102). As a result, the coordinate plane image 20 of FIG. 5 is displayed on the display of the display unit without the point graphic 31, the first and second dropline graphics 32 and 33, the first and second numerical values 34 and 35, and the function calculation result value 36.

The user may now operate the mouse to click on one point on the coordinate plane of the coordinate plane image 20 displayed on the display. The instruction receiving unit 14 then determines that an instruction specifying the position of the point graphic 31 has been received (step S103). The image generation unit 12 generates the point graphic image data and the like (step S104). More specifically, the image generation unit 12 generates the point graphic image data at the mouse-clicked position (step S201). It is assumed here that the position with a height of “170 (cm),” and a body weight of “85.0” (kg)” has been clicked on. The image generation unit 12 generates as the first and second dropline graphic image data the image data of the first and second dropline graphics 32 and 33 respectively perpendicularly extending to the first and second axes 21 and 22 from the point graphic 31 (step S202).

The numerical value acquiring unit 15 acquires the first numerical value “170” and the second numerical value “85.0” corresponding to the point graphic 31 on the coordinate plane (step S105). The output unit 16 then stores the first and second numerical values on the numerical value storage unit 17 (step S106). The calculation unit 18 calculates the value given by the predetermined function, i.e., the value of BMI (step S107). The equation used in this calculation is:

BMI=(second numerical value)/(first numerical value/100)²

If the first and second numerical values are those described above, the value of BMI is “29.4.”

The image generation unit 12 then generates the calculation result image data (step S108). More specifically, the image generation unit 12 generates the first and second numerical value image data corresponding to the first and second numerical values acquired by the numerical value acquiring unit 15 (step S301). The image generation unit 12 generates the calculation result image data responsive to the value of BMI calculated by the calculation unit 18 (step S302). Since the expansion graphic 37 is not displayed here, the generation process of the expansion graphic image data is not performed (step S303).

The image display unit 13 displays on the display thereof the image data such as the point graphic 31 generated by the image generation unit 12 (step S102). As a result, the screen of FIG. 5 is presented. The user may click on an “expansion display” button 41 on the screen of FIG. 5 to display the expansion graphic 37 using the mouse. The instruction receiving unit 14 receives an instruction to display the expansion graphic 37 (step S109). When the position of the “expansion display” button 41 is clicked on, the instruction receiving unit 14 may detect the clicking of the “expansion display” button 41 in accordance with information stored on the unillustrated recording medium. The information stored on the unillustrated recording medium maps the position of the “expansion display” button 41 to the type of the button 41. The same is true of another button. The image generation unit 12 determines that the instruction is an instruction to display the expansion graphic 37 (step S110), and then generates the expansion graphic image data corresponding to the position of the point graphic 31 illustrated in FIG. 5 (S111). The expansion graphic 37 is displayed on the display as illustrated in FIG. 6 (step S102). Since the area surrounding the position of the point graphic 31 is expanded into the expansion graphic 37, the user can position the point graphic 31 in a more detailed fashion. As a result, a numerical value may be input with a higher fineness.

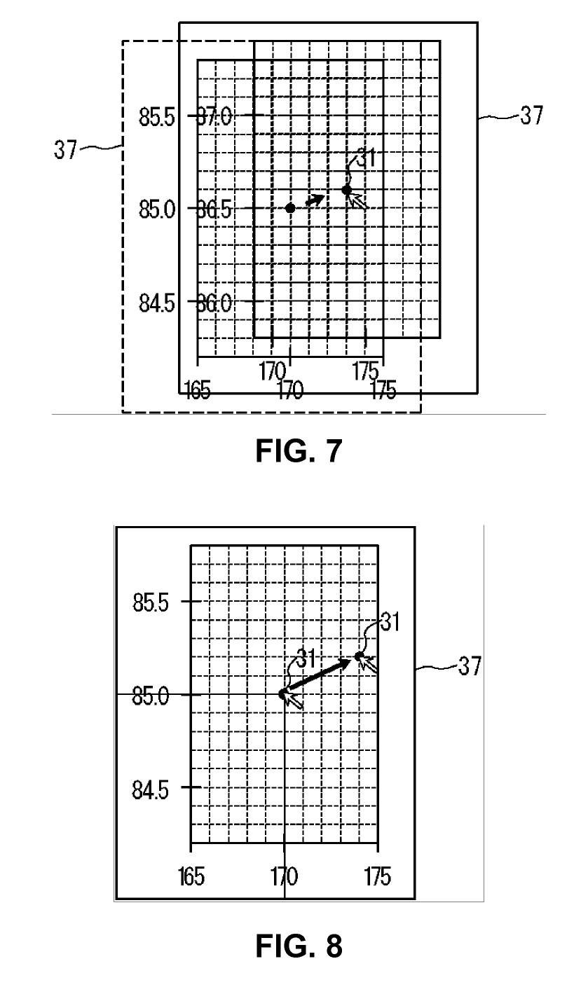

The position of the point graphic 31 may not be the position the user intends. Briefly described below is the operation to be performed if the user wants to know the degree of overweight with the value of the height being “174 (cm)” and the value of the body weight being “86.6 (kg).” On the screen of FIG. 6, the user may move the point graphic 31 by dragging the point graphic 31 with the mouse and the like or by clicking on a new point as a target on a coordinate plane with the mouse and the like. The image generation unit 12 generates at the position after movement the point graphic image data and the first and second dropline graphic image data (steps S103 and S104). The numerical value acquiring unit 15 acquires the first and second numerical values corresponding to the position of the point graphic 31 (step S105). The output unit 16 stores the first and second numerical values on the numerical value storage unit 17 (step S106). The calculation unit 18 calculates the value of BMI in accordance with the acquired first and second numerical values (S107). The image generation unit 12 generates the first and second numerical value image data, the function calculation result image data, and the expansion graphic image data displayed at the position of the point graphic 31 after the movement (steps S108, and S301-S304). These pieces of data are displayed on the display (step S102). The point graphic 31 is moved at a time in the process described above. The point graphic 31 may not necessarily be moved at a time. For example, the image display unit 13 may successively display the track of the point graphic 31 being dragged in the course of the movement thereof. The point graphic 31 may be moved by repeating steps S102-S108. According to the embodiment, the expansion graphic 37 also moves in unison with the movement of the point graphic 31. If the point graphic 31 moves from position (height, body weight)=(170, 85.0) to position (174, 86.6) as illustrated in FIG. 7, the expansion graphic 37 also moves in unison. In other words, the image generation unit 12 generates the expansion graphic image data with the display position thereof updated in response to the position of the point graphic 31. The point graphic 31 remains displayed at the center of the expansion graphic 37. If the expansion graphic 37 moves in unison with the movement of the point graphic 31, the values of the height and body weight on the expansion graphic 37 denoted by the point graphic 31 agree with the values of the height and body weight on the coordinate plane constituted of the first and second axes 21 and 22. Even with the expansion graphic 37 displayed, the numerical value acquiring unit 15 acquires the first and second numerical values in accordance with the client coordinate system of the coordinate plane constituted of the first and second axes 21 and 22, as discussed with reference to step S105.

According to the embodiment, if the point graphic 31 is moved with the expansion graphic 37 displayed, the expansion graphic 37 also moves in unison with the movement of the expansion graphic 37. Alternatively, the expansion graphic 37 does not necessarily move in unison. For example, As illustrated in FIG. 8, the expansion graphic 37 may remain stationary even if the point graphic 31 is moved. More specifically, if the position of the point graphic 31 is within the expansion area of the expansion graphic 37, the image generation unit 12 does not change the expansion graphic 37 in position. In such a case, the values of the height and body weight on the expansion graphic 37 denoted by the point graphic 31 may fail to agree with the values of the height and body weight on the coordinate plane constituted of the first and second axes 21 and 22. For example, as illustrated in FIG. 8, the values of the height and body weight on the expansion graphic 37 denoted by the point graphic 31 are (height, body weight)=(174, 85.2) but the values of the height and body weight on the coordinate plane constituted of the first and second axes 21 and 22 corresponding to the point graphic 31 after the movement may be (height, body weight)=(175, 88.2). A difference may be caused between the two graphics in this way. If the expansion graphic image data is erased, new point graphic image data on the coordinate plane constituted of the first and second axes 21 and 22 needs to be generated in response to the first and second numerical values on the expansion graphic 37 corresponding to the position of the point graphic 31. Subsequent to step S112 in the flowchart of FIG. 2, the image generation unit 12 needs to generate the point graphic image data.

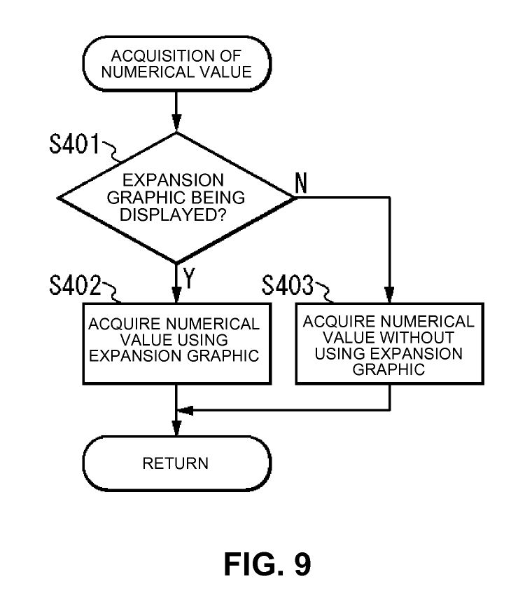

The acquisition method in the acquisition of the numerical value (step S105) in the flowchart is different depending on whether the expansion graphic is being displayed. The first and second numerical values need to be acquired in accordance with a flowchart of FIG. 9. The flowchart of FIG. 9 is discussed below.

Step S401 The numerical value acquiring unit 15 determines whether the expansion graphic 37 is being displayed. If the expansion graphic 37 is being displayed, processing proceeds to step S402. If the expansion graphic 37 is not being displayed, processing proceeds to step S403.

Step S402 The numerical value acquiring unit 15 acquires the first and second numerical values in the coordinate system of the expansion graphic 37. In this case, the conversion process of converting coordinate values in the screen coordinate system to coordinate values in the client coordinate system and the conversion process of converting the coordinate values in the client coordinate system into the values of height and body weight are performed with the coordinate system of the expansion graphic 37 serving as the client coordinate system. Processing returns to the flowchart of FIG. 2.

Step S403 The numerical value acquiring unit 15 acquires the first and second numerical values in the same way as the above-described step S105, and processing returns to the flowchart of FIG. 2.

If the expansion graphic 37 does not move in unison with the movement of the point graphic 31, it is not necessary to perform the operations in steps S303 and S304 in the flowchart of FIG. 4. However, if the point graphic 31 is moved beyond the range of the expansion graphic 37, a new expansion graphic 37 may or may not be generated. In the former case, the image generation unit 12 may generate the expansion graphic image data such that a new expansion graphic 37 appears to be centered on the position on the coordinate plane constituted of the first and second axes 21 and 22 and corresponding to the position of the last displayed point graphic 31 within the expansion graphic 37.

If the user clicks on a “general display” button 42 on the screen of FIG. 6, the expansion graphic image data is erased in response and the expansion graphic 37 ceases to be displayed (steps S109, S110, S112, and S102). If the user clicks on an “end” button 43 on the screen of FIG. 5, the coordinate plane image 20 and the like ceases to be displayed in response and disappears from the display (step S113).

The use of the first and second numerical values after being output is not limited to any particular use. For example, the values of the height and body weight input as described in the specific example may be added to a database of the user whose data has been input, or may find different applications.

In the numerical value input device 1 of the embodiment, the first and second numerical values are input on the coordinate plane using the GUI instead of the numeric keys. As a result, the numerical value input device 1 sets the user free from using both the pointing device and the numeric keys such as the keyboard to input the numerical values on the browser. The user thus enjoys an advantage of inputting numerical values using the pointing device alone. Since two numerical values are input at a time by determining the position of the point graphic 31, the input steps are small in number in comparison with the operation in which one numerical value is input at a time. User friendliness is thus increased. With the expansion graphic 37 displayed, a numerical value with a higher fineness is input. Since the first and second region boundary lines 23 and 24 partition the coordinate plane into a plurality of regions as illustrated in FIG. 5, attributes of the values given by the function (such as “overweight,” “normal,” and “underweight”) are easily learned. With the first and second numerical values 34 and 35 displayed, an accurate input value is easily learned. With the function calculation result value 36 displayed, the value given by the function responsive to the input values is easily learned. With the first and second dropline graphics 32 and 33 displayed, the positions in the first and second axes 21 and 22 corresponding to the point graphic 31 are easily identified. Since the expansion graphic 37 is part of the coordinate plane as illustrated in FIG. 6, the approximate position of the expansion graphic 37 with reference to the whole coordinate plane is easily learned even when the expansion graphic 37 is being displayed.

It is also generally considered that a fine adjustment on a grid such as the expansion graphic 37 is easier than a fine adjustment performed with the numerical value viewed. When an exact numerical value is read, reading the numerical value in displayed text is considered to be easier than reading the numerical value on the grid. For this reason, the expansion graphic 37 is displayed to move the point graphic 31 with a high fineness while the first and second numerical values 34 and 35 are displayed at the same time as illustrated in FIG. 6. The two purposes are thus achieved at the same time.

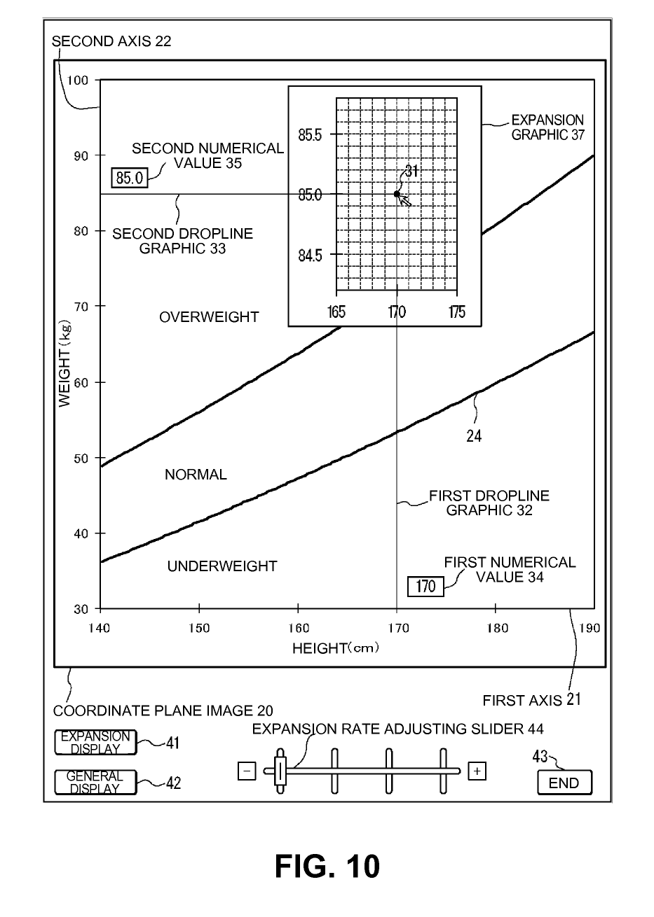

The expansion rate of the expansion graphic 37 may be set to be modifiable in the numerical value input device 1 of the embodiment. As illustrated in FIG. 10, an expansion rate adjusting slider 44 may increase or decrease the expansion rate. As a result, the expansion graphic 37 may be displayed at an expansion rate to the preference of the user. In this case, image data of a plurality of expansion graphics responsive to expansion rates may be pre-stored on the unillustrated recording medium, or image data of an expansion graphic responsive to an expansion rate may be generated in accordance with image data of an original expansion graphic. If the expansion graphic 37 remains stationary regardless of the movement of the point graphic 31, the numerical value acquiring unit 15 acquires the first and second numerical values in accordance with the expansion rate of the expansion graphic 37. In this case, the client coordinate system may be modified in response to the expansion rate of the expansion graphic 37, and the numerical value acquiring unit 15 may acquire the first and second numerical values in accordance with the coordinate values in the modified client coordinate system. Alternatively, the client coordinate system may not be modified, and the mapping between the coordinate values in the client coordinate system and the coordinate values in the expansion graphic 37 may be modified. The expansion rate of the expansion graphic also remains modifiable in embodiments to be discussed below.

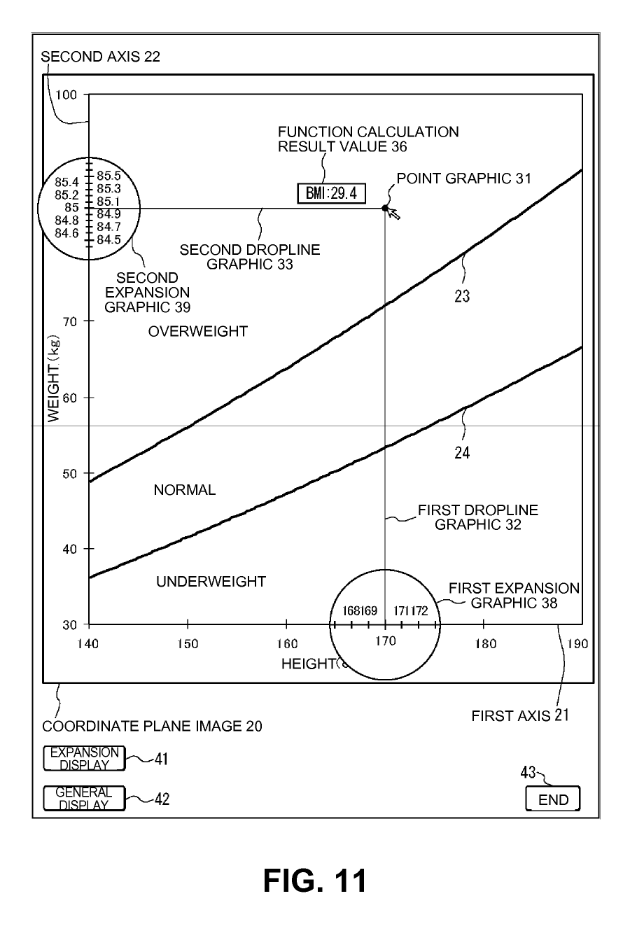

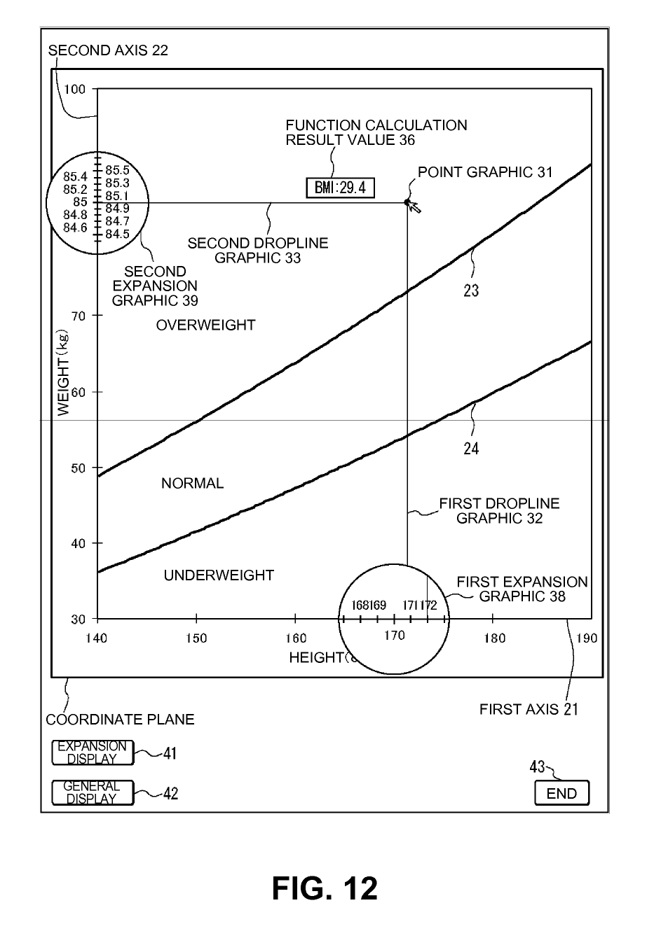

The expansion graphic 37 as an expansion area surrounding the position of the point graphic 31 has been discussed in the embodiment. Numerical values may be input using first and second expansion graphics 38 and 39 as expansion areas including positions corresponding to the point graphic 31, i.e., as parts of the first and second axes 21 and 22 as illustrated in FIG. 11. In such a case, the first and second expansion graphics 38 and 39 may remain displayed. More specifically, operations in steps S109-S112 may not be performed in the flowchart of FIG. 2. Operation in step S304 may be performed in standard process in the flowchart of FIG. 4. In other words, operation in step S303 is omitted, and processing proceeds from step S302 to step S304. The method of generating the first and second expansion graphic image data for displaying the first and second expansion graphics 38 and 39 is identical to the method of generating the expansion graphic image data, and the detailed discussion thereof is omitted herein. As the expansion graphic 37, the first and second expansion graphics 38 and 39 may or may not move in unison with the movement of the point graphic 31. In the latter case, the first dropline graphic 32 may be shifted in the boundary of the expansion graphic as illustrated in FIG. 12.

### Embodiment 2

A numerical value input device of an embodiment 2 of the invention is described with reference to the drawings. The numerical value input device of the embodiment is intended to input three arguments, with one argument at a time, and the remaining two arguments at another time.

The configuration of the numerical value input device of the embodiment is identical to that of the numerical value input device of FIG. 1. The numerical value input device 1 of the embodiment also includes the image data storage unit 11, the image generation unit 12, the image display unit 13, the instruction receiving unit 14, the numerical value acquiring unit 15, the output unit 16, the numerical value storage unit 17, and the calculation unit 18.

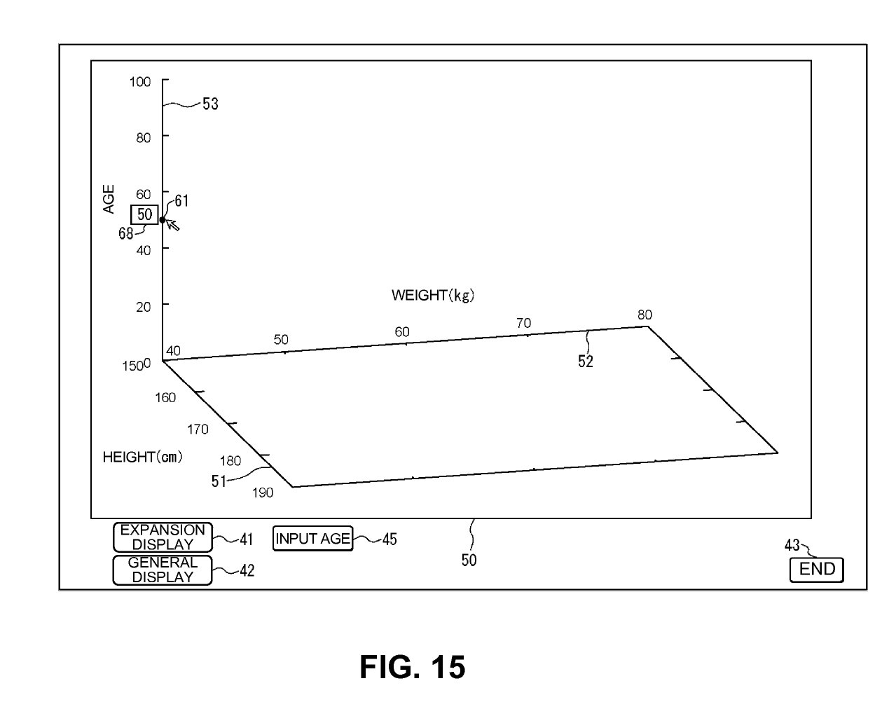

The image data storage unit 11 stores coordinate axis image data in addition to the coordinate plane image data. The coordinate plane image data is image data of the coordinate plane having the first axis and the second axis as previously described. The coordinate axis image data is image data of a third coordinate axis. A coordinate system of three-dimension may or may not be constituted of the coordinate plane image data and the coordinate axis image data. In the discussion of the embodiment, the former case is employed. For example, a coordinate space having a first axis 51, a second axis 52, and a third axis 53 is constructed of the coordinate plane image data and the coordinate axis image data as illustrated in FIG. 15. An image illustrating the coordinate space is referred to as a coordinate space image 50. The numerical value input device 1 of the embodiment inputs a first argument in the first axis 51, a second argument in the second axis 52, and a third argument in the third axis 53. In the embodiment, the third argument in the third axis 53 is input first, followed by the inputting of the first and second arguments in the first and second axes 51 and 52. In FIG. 15, the coordinate space is a perpendicular coordinate system, in which the first through third axes 51-53 are mutually perpendicular straight lines (the three straight lines are not illustrated as being perpendicular in the two-dimensional plane of FIG. 15 because the three-dimensional coordinate system is displayed using the two-dimensional plane). The coordinate space may not be a perpendicular coordinate system. The coordinate space may be an oblique coordinate system.

In the discussion of the embodiment, the height, the body weight, and the age of a person are input to calculate basal energy expenditure (basal metabolic rate). The first axis 51 represents the height (cm) as one argument, the second axis 52 represents the body weight (kg) as another argument, and the third axis 53 represents the age as yet another argument. Any axis may be allocated to any argument as in the embodiment 1.

Equation representing the basal energy expenditure is known as Harris-Benedict equation as described below (equation here is for males)

Basal energy expenditure (kcal/day)=66.47+13.75×body weight (kg)+5.003×height (cm)−6.775×age

The equation here shows that a constant value of basal energy expenditure represents a plane in the coordinate system with the three axes representing height, body weight, and age. A region boundary plane may or may not be displayed in the coordinate space of FIG. 15. The region boundary plane is a plane representing the relationship of height, body weight, and age providing a value of basal energy expenditure (hereinafter referred to as a “boundary value”). In the discussion of the embodiment, the region boundary plane is not displayed.

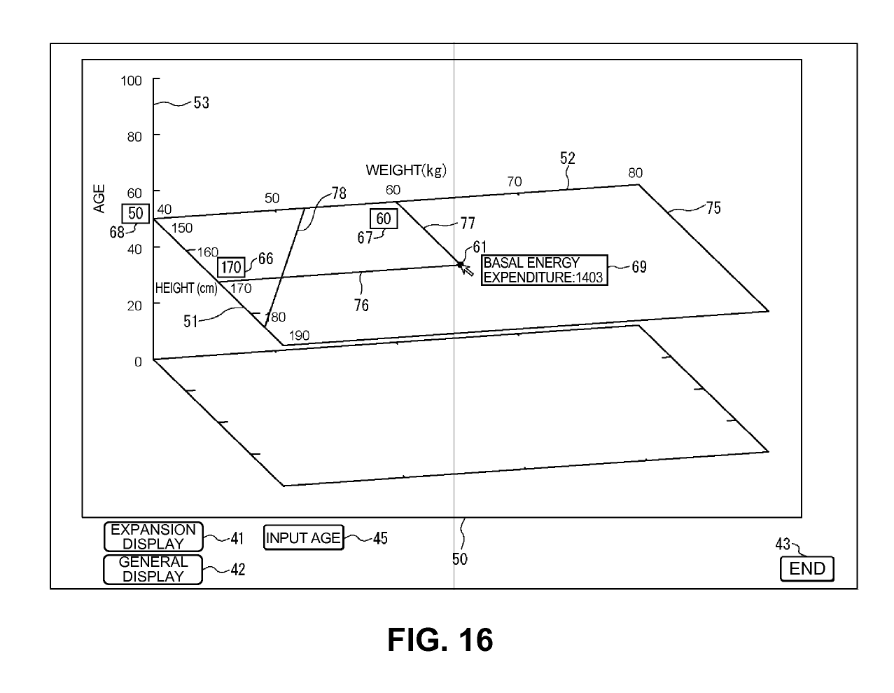

The coordinate plane image data is a predetermined function (the above-described Harris-Benedict equation in the embodiment) with the value in the first axis 51, the value in the second axis 52, and the value in the third axis 53 serving as arguments. The coordinate plane image data may be image data of a coordinate plane that is partitioned into a plurality of regions in response to a value given by the function in which the third numerical value acquired by the numerical value acquiring unit 15 is substituted for the value in the third axis 53. According to the embodiment, the coordinate plane is partitioned into two regions by a line of intersection where the coordinate plane of the coordinate plane image data intersects the region boundary plane. In the embodiment, the boundary value may be “1200 (kcal/day).” The boundary value may be any other appropriate value. A region boundary line 78 partitions the coordinate plane into two regions in the coordinate space image 50 of FIG. 16 corresponding to the coordinate plane image data and the coordinate axis image data. More specifically, the coordinate plane is partitioned into a region where the basal energy expenditure is higher than 1200 (kcal/day) (to the right of the region boundary line 78 in FIG. 16) and a region where the basal energy expenditure is lower than 1200 (kcal/day) (to the left of the region boundary line 78 in FIG. 16). The regions may be colored with different colors or marked with different hatchings to visibly easily discriminate each region. A phrase “Basal energy expenditure: high” featuring the region may be displayed in the region having a basal energy expenditure higher than 1200 (kcal/day), and a phrase “Basal energy expenditure: low” featuring the region may be displayed in the region having a basal energy expenditure lower than 1200 (kcal/day).

In the embodiment, the image generation unit 12 generates the point graphic image data, the expansion graphic image data, the first through third numerical value image data, the function calculation result image data, and the first and second dropline graphic image data. These pieces of data are described with reference to FIGS. 15 through 17.

The point graphic image data is image data of a point graphic 61. The point graphic 61 is a graphic denoting a position on the coordinate plane represented by the coordinate plane image data or a position on the coordinate axis represented by the coordinate axis image data. The third numerical value in the third axis 53 and the values in the first and second axes 51 and 52 corresponding to the output unit 16 are specified by specifying the position of the point graphic 61. In the embodiment, the numerical value is input using a single point graphic 61. Numerical values may be input using two point graphics, i.e., a point graphic specifying the position in the third axis 53 and a point graphic specifying the position on the coordinate plane constituted of the first and second axes 51 and 52. The discussion of the point graphic 61 remains unchanged from that of the point graphic 31 in the embodiment 1, and is thus omitted here.

The expansion graphic image data is image data of an expansion graphic 79. The expansion graphic 79 is part of the coordinate plane constituted of the first and second axes 51 and 52, and is an expansion area including the point graphic 61. The expansion graphic 79 is identical to the expansion graphic 37 of the embodiment 1, and the discussion thereof is omitted herein.

The first through third numerical value image data is image data of first through third numerical values 66, 67, and 68. The first through third numerical values correspond to the values, in the first through third axes 51-53 corresponding to the position of the point graphic 61, acquired by the numerical value acquiring unit 15. The first through third numerical value image data is identical to the first and second numerical value image data of the embodiment 1, and the discussion thereof is omitted herein. The first through third numerical values 66, 67, and 68 may or may not be displayed in the positions of the first through third axes 51-53 corresponding to the first through third numerical values.

The function calculation result image data is image data of the function calculation result value 36 calculated by the calculation unit 18 to be discussed later. The function calculation result image data is identical to the function calculation result image data of the embodiment 1, and the discussion thereof is omitted herein.

The first and second dropline graphic image data is image data of first and second dropline graphics 76 and 77. The first and second dropline graphics 76 and 77 are respectively dropline graphics drawn from the point graphic 61 to the first and second axes 51 and 52. The first and second dropline graphic image data is identical to the first and second dropline graphic image data of the embodiment 1, and the discussion thereof is omitted herein.

The image generation unit 12 may generate the expansion graphic image data with the display position thereof changed in response to the position of the point graphic 61. If the position of the point graphic 61 is within the expansion area of the expansion graphic 79, it is not necessary to change the position of the expansion graphic 79 as it is not necessary in the embodiment 1. The former case is described with reference to the embodiment as has been described with reference to the embodiment 1 as above.

The image generation unit 12 may generate the image data of the region boundary line 78. The image generation unit 12 generates the image data of a trace of the predetermined function on the coordinate plane. In the predetermined function (the Harris-Benedict equation in the embodiment), the image generation unit 12 substitutes a boundary value (1200 kcal/day in the embodiment) for the value (the basal energy expenditure in the embodiment), and substitutes a third numerical value acquired by the numerical value acquiring unit 15 for the value in the third axis 53. The image generation unit 12 thus generates the image data of the region boundary line 78. The generated image data of the region boundary line 78 may be added onto the coordinate plane image data stored on the image data storage unit 11. The image generation unit 12 may not generate the image data of the region boundary line 78. For example, the image data of the region boundary line 78 of different third numerical values may be included in the coordinate plane image data stored on the image data storage unit 11. In the reading of the coordinate plane image data, the image display unit 13 may read the image data of the region boundary line 78 corresponding to the third numerical value acquired by the numerical value acquiring unit 15 such that the region boundary line 78 is displayed on the coordinate plane.

The image display unit 13 is identical to the counterpart in the embodiment 1 except that the image display unit 13 of the embodiment also displays the coordinate plane image data and the third numerical value image data read from the image data storage unit 11, and the discussion thereof is omitted herein. The image display unit 13 may display the coordinate plane image data and the coordinate axis image data in a manner such that the first through third axes 51-53 constitute the coordinate space, or may display the coordinate plane image data and the coordinate axis image data separately. If the coordinate plane image data and the coordinate axis image data are displayed in a manner such that the first through third axes 51-53 constitute the coordinate space, the image display unit 13 may or may not display the coordinate plane image data at a predetermined position in the third axis 53. In the latter case, the image display unit 13 may display the coordinate plane image data corresponding to the position in the third axis 53 responsive to the third numerical value acquired by the numerical value acquiring unit 15 to be discussed later (the acquisition of the third numerical value is described below).

In addition to the same process as that of the instruction receiving unit 14 in the embodiment 1, the instruction receiving unit 14 in this embodiment may receive an instruction to end the inputting to the third axis 53. According to the embodiment, a numerical value to the third axis 53 is first received, followed by the reception of the numerical values to the first and second axes 51 and 52.

The numerical value acquiring unit 15 acquires the third numerical value as the value in the third axis 53 corresponding to the position of the point graphic 61, the first numerical value as the value in the first axis 51 and the second numerical value as the value in the second axis 52 corresponding to the position of the point graphic 61 on the coordinate plane constituted of the first and second axes 51 and 52. The method of the numerical value acquiring unit 15 for acquiring the numerical value is identical to the method of the embodiment 1, and the discussion thereof is omitted herein.

When the numerical value acquiring unit 15 acquires the third numerical value, the point graphic 61 may be present in the third axis 53 or may be present in the coordinate space. The former case is discussed in connection with the embodiment. More specifically, the image generation unit 12 restricts the movement of the point graphic 61 such that the point graphic 61 moves only along the third axis 53 when the third argument is input. In the latter case, i.e., when the third numerical value corresponding to the position of the point graphic 61 present in the coordinate space is acquired, the operation to be performed may be the same as when the first and second numerical values corresponding to the position of the point graphic 31 present on the coordinate plane in the embodiment 1 are acquired. In such a case, the image generation unit 12 may generate the dropline graphic image data as the image data of the dropline drawn from the point graphic 61 to the third axis 53.

The output unit 16 outputs the third numerical value acquired by the numerical value acquiring unit 15. The rest of the operation of the output unit 16 remains unchanged from that of the output unit 16 in the embodiment 1, and the discussion thereof is omitted herein.

The calculation unit 18 calculates the value given by the predetermined function using as arguments the first through third numerical values acquired by the numerical value acquiring unit 15. In the embodiment, the predetermined equation is the Harris-Benedict equation calculating basal energy expenditure based on height, body weight, and age.

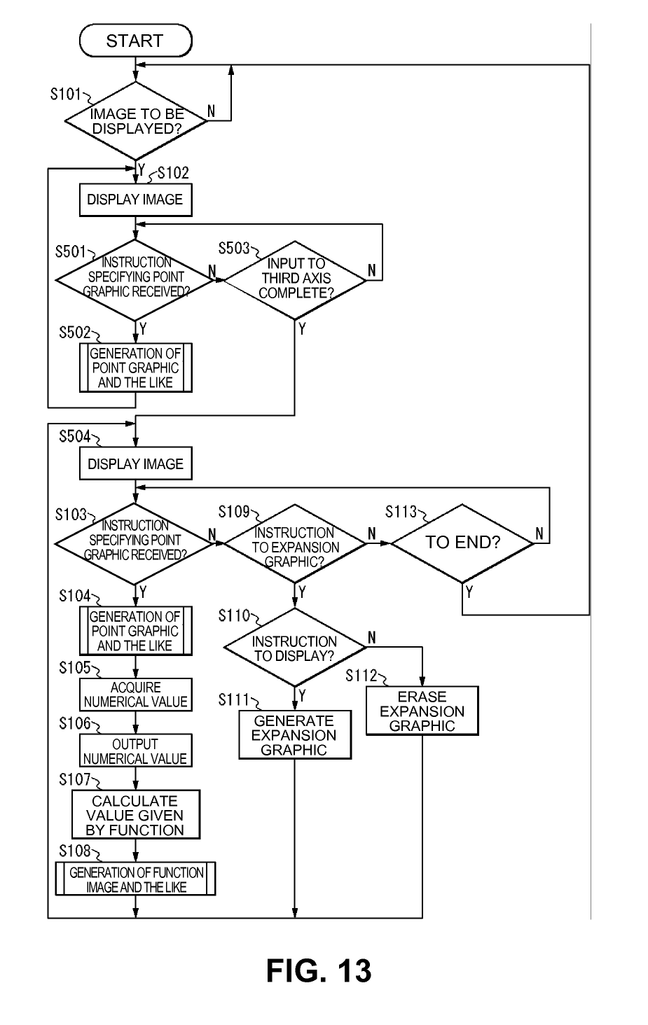

The process of the numerical value input device 1 of the embodiment is described with reference to the flowchart of FIG. 13. Operations other than steps S501-S504 are identical to the counterparts in the flowchart of FIG. 2 of the embodiment 1 except for the above-described difference in which the coordinate axis image data is displayed together with the coordinate plane image data in the embodiment, and the discussion thereof is omitted herein.

Step S501 The instruction receiving unit 14 determines whether the instruction to specify the position of the point graphic 61 has been received. If the instruction has been received, processing proceeds to step S502. If the instruction has not been received, processing proceeds to step S503. As described above, it is assumed in the embodiment that if the instruction for the point graphic 61 has been received, the point graphic 61 is set to move along the third axis 53 only.

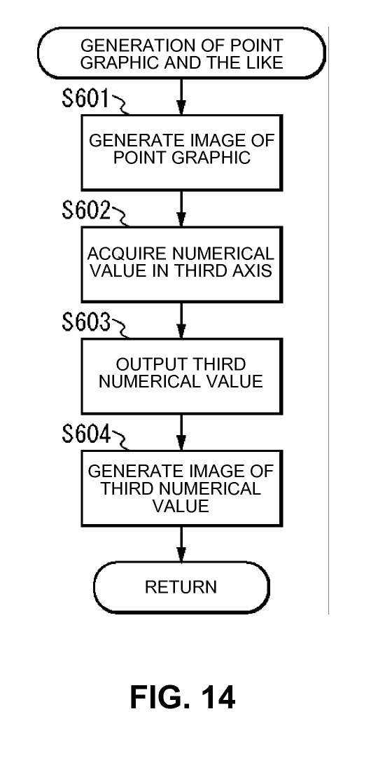

Step S502 The image generation unit 12 generates the image data of the point graphic and the like in response to the received instruction. The operation in this step is described in detail below with reference to a flowchart of FIG. 14.

Step S503 The instruction receiving unit 14 determines whether an instruction to end the inputting to the third axis 53 has been received. To end the inputting to the third axis 53, processing proceeds to step S504. If not, processing proceeds to step S501.

Step S504 The image display unit 13 displays the coordinate plane image data and the coordinate axis image data read from the image data storage unit 11, and the image data generated by the image generation unit 12. The image display unit 13 displays a coordinate plane 75 of the coordinate plane image data corresponding to the position in the third axis 53 responsive to the third numerical value acquired in operations in steps S501-S503. In the displaying of the coordinate plane image data and the like for the first time, the image display unit 13 may or may not display the point graphic 61 at a predetermined position, and the first and second dropline graphics 76 and 77, the first and second numerical values 66 and 67, the value 69 of the function calculation result and the like corresponding to the point graphic 61.

The numerical value inputting to the third axis 53 is performed in steps S501-S503 in the flowchart of FIG. 13, and the numerical value inputting to the first and second axes 51 and 52 is performed in steps S504 and S103-S112.

FIG. 14 is the flowchart illustrating in detail the generation operation (step S502) of the point graphic and the like in the flowchart of FIG. 13.

Step S601 The image generation unit 12 generates the point graphic image data in response to the instruction specifying the position of the point graphic 61 received by the instruction receiving unit 14. For example, if the received instruction is an instruction to move the point graphic 61, the image generation unit 12 deletes the point graphic image data at this point of time, and generates the point graphic image data at a movement destination. For example, if the received instruction is an instruction to newly display the point graphic 61, the image generation unit 12 generates a point graphic at a specified position. The generation of the point graphic image data may be performed using the point graphic 61 pre-stored on an unillustrated recording medium. The generation of the point graphic image data may be an operation of determining a display position of the point graphic 61, for example.

Step S602 The numerical value acquiring unit 15 acquires the third numerical value corresponding to the position of the point graphic 61. For example, the numerical value acquiring unit 15 acquires coordinate values in the screen coordinate system corresponding to the position of the point graphic 61. In the same manner as described with reference to the embodiment 1, the coordinate values in the screen coordinate system are converted into coordinate values in the client coordinate system. It is assumed that a lower limit value (“0” in FIG. 15) and an upper limit value (“100” in FIG. 15) in the third axis 53 are mapped to corresponding coordinate values in the client coordinate system. The numerical value acquiring unit 15 thus acquires the corresponding value in the third axis 53 from the coordinate values in the client coordinate system in accordance with the mapping.

Step S603 The output unit 16 outputs the third numerical value acquired by the numerical value acquiring unit 15. More specifically, the output unit 16 stores the third numerical value on the numerical value storage unit 17.

Step S604 The image generation unit 12 generates the third numerical value image data in accordance with the third numerical value acquired by the numerical value acquiring unit 15. For example, the image generation unit 12 may generate the third numerical value image data by reading, as source image data, image data of a graphic such as a frame pre-stored on the unillustrated recording medium, and substituting the third numerical value in text into the image data. The display position of the third numerical value 68 may be set to be close to the third numerical value in the third axis 53. In this case, the display position of the third numerical value 68 may be determined by converting the coordinate system of the third axis 53 into the client coordinate system. Processing returns to the flowchart of FIG. 13.

The process of the numerical value input device 1 of the embodiment is described below with reference to a specific example. In this example, the image display unit 13 displays each image data on the display thereof.

The user may now operate the mouse or the keyboard to input on the numerical value input device 1 an instruction to output the coordinate space image 50. The image display unit 13 determines that it is time to display the image data (step S101). The image display unit 13 reads the coordinate plane image data and the coordinate axis image data from the image data storage unit 11 and outputs the read coordinate plane image data and coordinate axis image data to the display (step S102). As a result, the screen illustrated in FIG. 5 is displayed. The screen without the point graphic 61 and the third numerical value 68 is thus displayed on the display.

The user may now operate the mouse to click on one point in the third axis 53 displayed on the display. The instruction receiving unit 14 determines that an instruction specifying the position of the point graphic 61 has been received (step S501). The image generation unit 12 generates the point graphic and the like (step S502). More specifically, the image generation unit 12 generates the point graphic image data on the third axis 53 that has been mouse-clicked (step S601). A position corresponding to the age of “50” may now be clicked here. The numerical value acquiring unit 15 acquires a third numerical value “50” corresponding to the point graphic 61 (step S602). The output unit 16 stores the third numerical value on the numerical value storage unit 17 (step S603). The image generation unit 12 generates the third numerical value image data corresponding to the third numerical value acquired by the numerical value acquiring unit 15 (step S604).

The image display unit 13 displays on the display the image data such as the point graphic 61 generated by the image generation unit 12 (step S102). As a result, a screen of FIG. 15 is displayed. The user may now click on an “input age” button 45 displayed on the screen on the display using the mouse. The instruction receiving unit 14 receives an instruction to end the inputting to the third axis (step S503). The image display unit 13 displays on the display the coordinate plane 75 at a position in the third axis 53 corresponding to the third numerical value “50” acquired by the numerical value acquiring unit 15 (step S504). As a result, the screen of FIG. 16 is displayed. The screen displayed on the display is without the point graphic 61, the first and second dropline graphics 76 and 77, the first and second numerical values 66 and 67, and the function calculation result value 69. In FIG. 16, axes corresponding to the first and second axes 51 and 52 remain displayed at the positions where the first and second axes 51 and 52 are displayed in FIG. 15. These axes may not be displayed.

The user may now click on one point on the coordinate plane 75 constituted of the first and second axes 51 and 52 displayed on the display by operating the mouse. The instruction receiving unit 14 then determines that an instruction specifying the position of the point graphic 61 has been received (step S103). The image generation unit 12 generates the point graphic image data and the like (step S104). More specifically, the image generation unit 12 generates the point graphic image data at the mouse-clicked position (step S201). It is assumed here that the position with a height of “170 (cm),” and a body weight of “60.0” (kg)” has been clicked on. The image generation unit 12 generates as the first and second dropline graphic image data the image data of the first and second dropline graphics 76 and 77 respectively perpendicularly extending to the first and second axes 51 and 52 from the point graphic 61 (step S202).

The numerical value acquiring unit 15 acquires the first numerical value “170” and the second numerical value “60.0” corresponding to the point graphic 61 on the coordinate plane 75 (step S105). The output unit 16 then stores the first and second numerical values on the numerical value storage unit 17 (step S106). The calculation unit 18 calculates the value given by the predetermined function, i.e., the value of basal energy expenditure (step S107). The calculation unit 18 acquires the third numerical value from the numerical value storage unit 17 via an unillustrated path and uses the third numerical value in calculation. If the first through third numerical values are those described above, basal energy expenditure is “1403 (kcal/day).”

The image generation unit 12 generates the function calculation result image data (step S108). More specifically, the image generation unit 12 generates the first and second numerical value image data corresponding to the first and second numerical values acquired by the numerical value acquiring unit 15 (step S301). The image generation unit 12 also generates the function calculation result image data corresponding to the value of basal energy expenditure calculated by the calculation unit 18 (step S302). Since the expansion graphic 79 is not displayed here, it is not necessary to generate the expansion graphic image data (step S303).

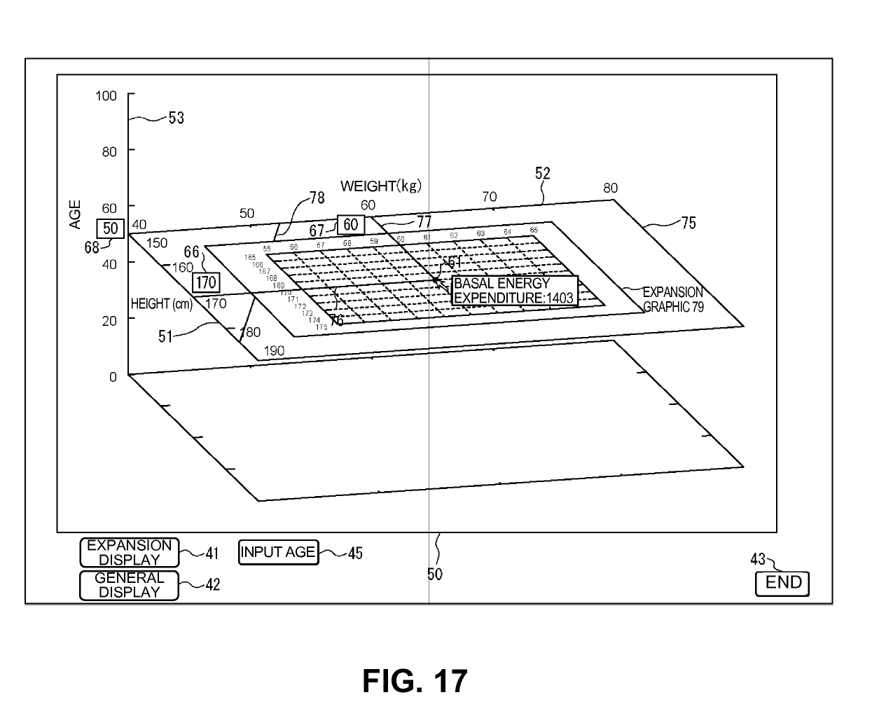

The image display unit 13 displays on the display the image data of the point graphic 61 and the like generated by the image generation unit 12 (step S504). As a result, the screen of FIG. 16 is displayed. On the screen of FIG. 16, the user may click on an “expansion display” button 41 displayed on the display using the mouse in order to display the expansion graphic 79. The instruction receiving unit 14 then receives an instruction to display the expansion graphic 79 (step S109). The image generation unit 12 determines that the instruction is an instruction to display the expansion graphic 79 (step S110), and then generates the expansion graphic image data corresponding to the position of the point graphic 61 illustrated in FIG. 16 (S111). The expansion graphic 79 is displayed on the display as illustrated in FIG. 17 (step S102). Since the area surrounding the position of the point graphic 61 is expanded into the expansion graphic 79, the user can position the point graphic 61 more in detail. As a result, a numerical value may be input with a higher fineness.

The position of the point graphic 61 may not be the position the user intends. The process to be performed in such a case is identical to the specific process of the embodiment 1. The discussion of the process is thus omitted. If the point graphic 61 is moved with the expansion graphic 79 displayed, the expansion graphic 79 also moves in unison with the movement of the point graphic 61 in the embodiment. The expansion graphic 79 may not move in unison as the point graphic does not necessarily move in unison in the embodiment 1. If the user click on a “general display” button 42 on the screen of FIG. 17, the expansion graphic image data is erased in response, and the expansion graphic 79 ceases to be displayed as illustrated in FIG. 16, in the same manner as in the embodiment 1.

As described above, the numerical value input device 1 of the embodiment inputs the first through third numerical values using the GUI in the coordinate space instead of the numeric keys. Since the first and second numerical values are input at a time in such a case, the same advantages as those of the embodiment 1 are provided.

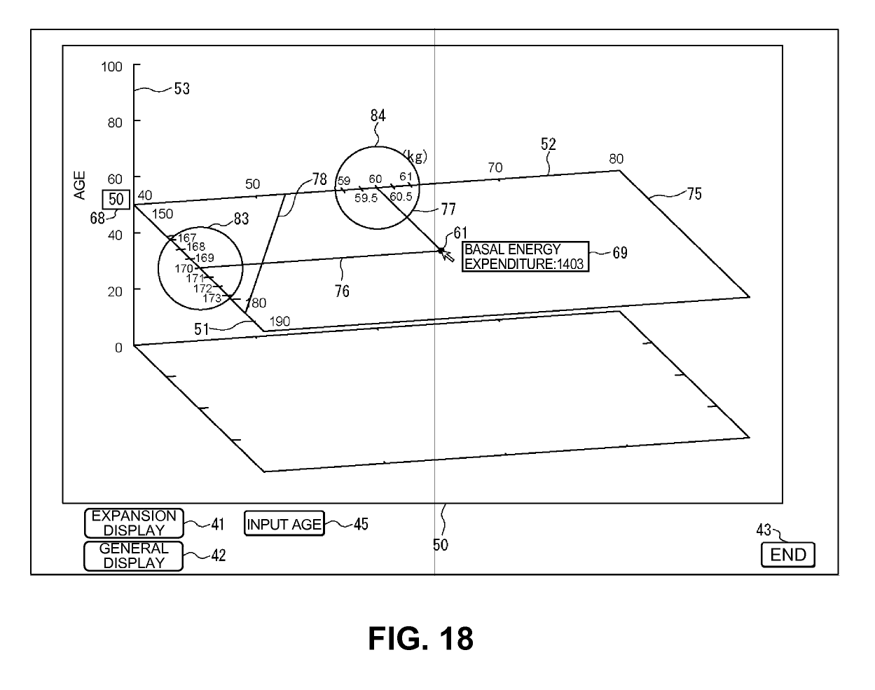

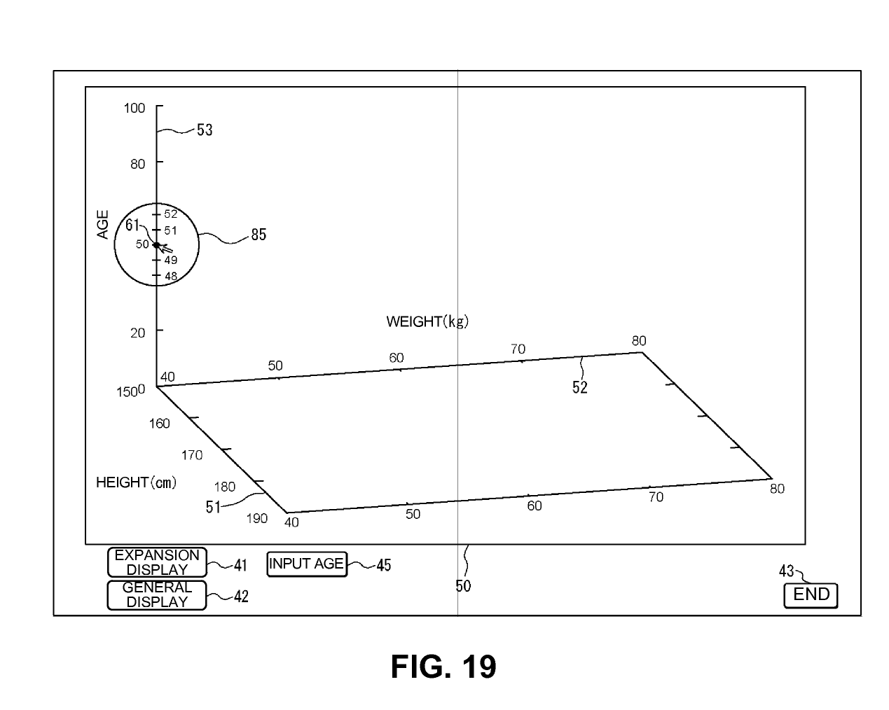

According to the embodiment, the expansion graphic 79 having the area surrounding the position of the point graphic 61 is used. As described with reference to the embodiment 1, the numerical value may be input using first and second expansion graphics 83 and 84 illustrated in FIG. 18. The third numerical value may be input using a third expansion graphic 85 illustrated in FIG. 19. A process of generating the image data of the third expansion graphic 85 may be performed at the end of the process of the flowchart of FIG. 14. The first through third expansion graphics 83-85 may or may not be moved in unison with the movement of the point graphic 61 as in the embodiment 1.

### Embodiment 3

A numerical value input device of an embodiment 3 of the invention is described with reference to the drawings. The numerical value input device of the embodiment inputs a single argument.

The configuration of the numerical value input device of the embodiment remains identical to that of the numerical value input device illustrated in FIG. 1. The numerical value input device 1 of the embodiment thus includes the image data storage unit 11, the image generation unit 12, the image display unit 13, the instruction receiving unit 14, the numerical value acquiring unit 15, the output unit 16, the numerical value storage unit 17, and the calculation unit 18.

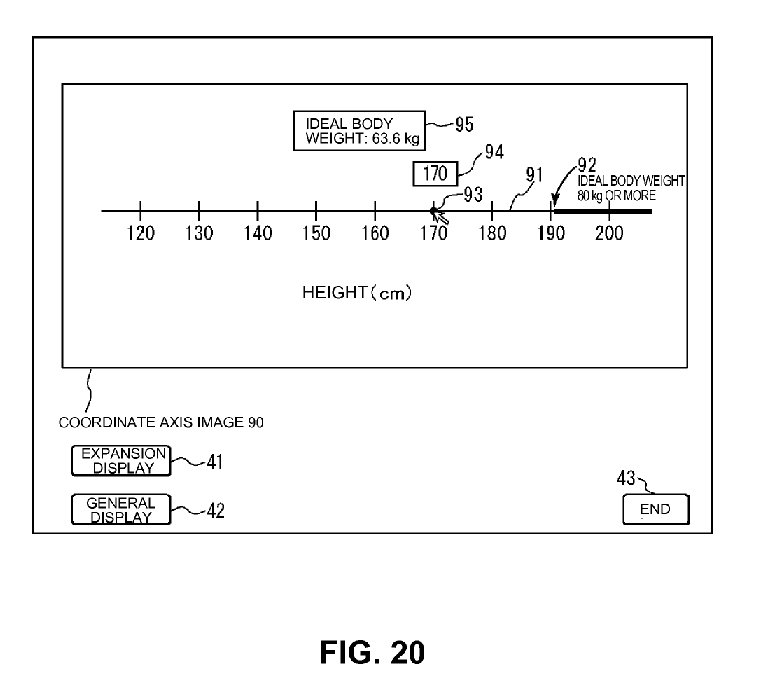

The image data storage unit 11 here stores the coordinate axis image data. The coordinate axis image data is image data of a coordinate axis. As illustrated in FIG. 20, the coordinate axis image data of the embodiment is the image data of a first axis 91 as the coordinate axis. The numerical value input device 1 of the embodiment inputs a first argument in the first axis 91. In the discussion of the embodiment, the first axis 91 is a straight line. The first axis 91 may not be a straight line. The first axis 91 may be a curved line.

In the discussion of the embodiment, the numerical value input device 1 inputs the value of height to calculate ideal body weight. The first axis 91 is an axis denoting height (cm) as an argument. As illustrated in FIG. 20, the first axis 91 may or may not horizontally extend. The first axis 91 may vertically extend or may extend in a different direction. As in the embodiment 1, the name of an argument denoted by the first axis 91 may be displayed close to the first axis 91, and each axis may be marked with gradations and numerical values.

Equation for calculating the ideal body weight with the BMI=22 is described below.

Ideal body weight (kg)=22×{height (m)}²

As understood from the equation, the ideal body weight is an increasing function with height. A boundary point serving as the value of the ideal body weight may be displayed on the coordinate axis as illustrated in FIG. 20. A boundary point 92 between a heavy line and a fine line along the first axis 91 serves as a boundary point of 80 (kg) of ideal body weight. The boundary point 92 may have a different value. As illustrated in FIG. 20, a heavy line range along the first axis 91 is a range where the ideal body weight is 80 (kg) or heavier. The coordinate axis image data may be partitioned into a plurality of regions in response to the value given by the predetermined function (the equation of the ideal body weight in the embodiment) having as an argument a value in the coordinate axis (height in the embodiment). As illustrated in FIG. 20, the thickness of the line may be changed depending on the region. Alternatively, depending on the region, the line may be changed in type (such as a solid line, a broken line, a wavy line, and the like), or may be changed in color. Each region may be visibly easily discriminated in this way. A phrase defining the region “ideal body weight of 80 kg or heavier” may be displayed in a region of an ideal body weight of 80 (kg) or heavier (a heavy line region to the right of the boundary point 92 in FIG. 20). No label is attached on a region of an ideal body weight of 80 (kg) or lighter in FIG. 20. In this region as well, a phrase defining the region such as “ideal body weight of 80 kg or lighter” may be displayed.

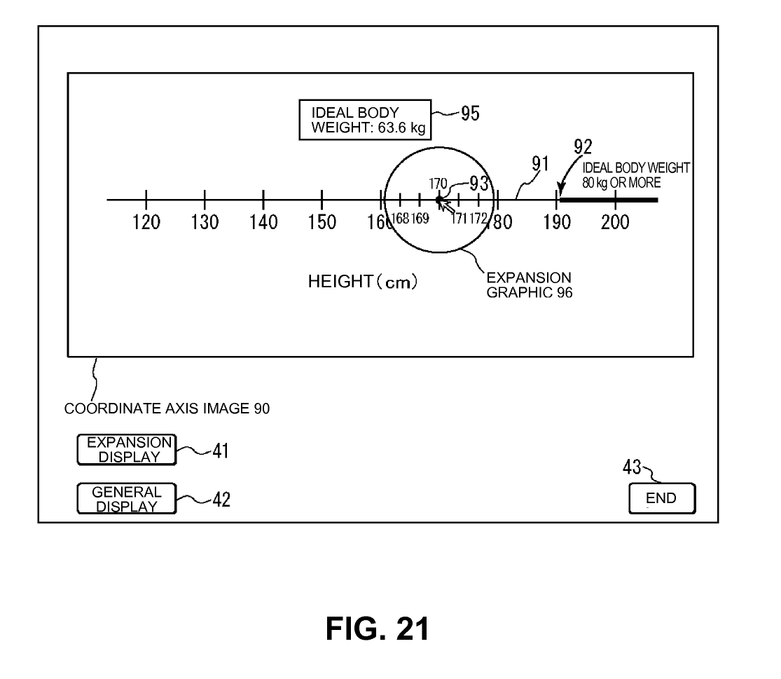

In the embodiment, the image generation unit 12 generates the point graphic image data, the expansion graphic image data, the first numerical value image data, and the function calculation result image data. These pieces of data are described with reference to FIGS. 20 and 21.

The point graphic image data is image data of a point graphic 93. The point graphic 93 is a graphic representing a position in the coordinate axis represented by the coordinate axis image data. The value in the first axis 91 corresponding to the point graphic 93 is input by specifying the position of the point graphic 93. The discussion of the point graphic 93 remains unchanged from that of the point graphic 31 of the embodiment 1, and is thus not repeated herein.

The expansion graphic image data is image data of an expansion graphic 96. The expansion graphic 96 is a region which is part of the first axis 91 and into which an area including the position of the point graphic 93 is expanded. The expansion graphic 96 is identical to the expansion graphic 37 of the embodiment 1 except that the expansion graphic 96 is an expansion graphic in a one-dimensional axis, and the discussion thereof is omitted herein.

The first numerical value image data is image data of a first numerical value 94. The first numerical value is a value in the first axis 91 corresponding to the point graphic 93 acquired by the numerical value acquiring unit 15 to be discussed later. The first numerical value image data is identical to the first and second numerical value image data of the embodiment 1, and the discussion thereof is omitted herein. The first numerical value 94 may or may not be displayed close to the position of the first axis 91 corresponding to the first numerical value.

The function calculation result image data is image data of the value given by the predetermined function calculated by the calculation unit 18 to be discussed below. The value given by the predetermined function is identical to the value given by the predetermined function of the embodiment 1, and the discussion thereof is omitted herein.

Since the point graphic 93 is displayed on the first axis 91 in the embodiment, the image generation unit 12 does not generate the dropline graphic image data in the following discussion. If the point graphic 93 is spaced apart from the first axis 91 on the screen, the image generation unit 12 may generate, as the dropline graphic image data, image data of a dropline graphic extending from the point graphic 93 to the position of the value in the first axis 91 corresponding to the point graphic 93.

As in the embodiment 1, the image generation unit 12 may generate the expansion graphic image data with the display position thereof changed in response to the position of the point graphic 93, and if the position of the point graphic 93 is within the expansion area of the expansion graphic 96, the image generation unit 12 may not modify the position of the expansion graphic 96. The former case is described in the embodiment as is described with reference to the embodiment 1.

The image display unit 13 is identical to the counterpart in the embodiment 1 except that the image display unit 13 in the embodiment displays the coordinate axis image data read from the image data storage unit 11, and the discussion thereof is omitted herein.

The numerical value acquiring unit 15 acquires the first numerical value corresponding to the position of the point graphic 93 in the coordinate axis. The method of the numerical value acquiring unit 15 for acquiring the numerical value remains unchanged from the method in the embodiment 1, and the discussion thereof is omitted herein.

The output unit 16 outputs the first numerical value acquired by the numerical value acquiring unit 15. The method of the output unit 16 for outputting the numerical value is identical to the method in the embodiment 1, and the discussion thereof is omitted herein.

The calculation unit 18 calculates the value given by the predetermined function using as an argument the first numerical value acquired by the numerical value acquiring unit 15. In the embodiment, the predetermined function is a function for calculating ideal body weight from height.

The process of the numerical value input device 1 of the embodiment is identical to the process of the flowchart of the embodiment 1 illustrated in FIG. 2, and the discussion thereof is omitted herein. However, since the image generation unit 12 does not generate the dropline graphic image data, the operation in step S202 is not necessary.

A specific example of the process of the numerical value input device 1 of the embodiment is described below. In this specific example, the image display unit 13 displays each of the data on a display thereof.

The user may now operate the mouse or the keyboard to input on the numerical value input device 1 an instruction to output a coordinate axis image 90. The image display unit 13 determines that it is time to display the image data (step S101). The image display unit 13 reads the coordinate axis image data from the image data storage unit 11 and outputs the read coordinate axis image data to the display (step S102). As a result, the coordinate axis image 90 of FIG. 20 is displayed on the display of the display unit with none of the point graphic 93, the first numerical value 94, and the value 95 of the function calculation result.

The user may now operate the mouse to click on one point in the coordinate axis of the coordinate axis image 90 displayed on the display. The instruction receiving unit 14 then determines that an instruction specifying the position of the point graphic 93 has been received (step S103). The image generation unit 12 generates the point graphic image data (step S104). More specifically, the image generation unit 12 generates the point graphic image data at the mouse-clicked position (step S201). It is assumed here that the position with a height of “170 (cm)” has been clicked on.

The numerical value acquiring unit 15 acquires the first numerical value “170” corresponding to the point graphic 93 on the coordinate plane (step S105). The output unit 16 then stores the first numerical values on the numerical value storage unit 17 (step S106). The calculation unit 18 calculates the value given by the predetermined function, i.e., the value of ideal body weight (step S107). The equation used in this calculation is:

Ideal body weight=22×{first numerical value/100}²

If the first numerical value is the above-described value, the value of ideal body weight is “63.6 (kg).”

The image generation unit 12 then generates the function calculation result image data (step S108). More specifically, the image generation unit 12 generates the first numerical value image data corresponding to the first numerical value acquired by the numerical value acquiring unit 15 (step S301). The image generation unit 12 generates the calculation result image data responsive to the value of ideal body weight calculated by the calculation unit 18 (step S302). Since the expansion graphic 96 is not displayed here, the generation process of the expansion graphic image data is not performed (step S303).

The image display unit 13 displays on the display thereof the image data such as the point graphic 93 generated by the image generation unit 12 (step S102). As a result, the screen of FIG. 20 is presented. The user may click on an “expansion display” button 41 on the screen of FIG. 20 to display the expansion graphic 96 by operating the mouse. The instruction receiving unit 14 receives an instruction to display the expansion graphic 96 (step S109). Upon determining that the instruction is an instruction to display the expansion graphic 96 (step S110), the image generation unit 12 generates the expansion graphic image data corresponding to the position of the point graphic 93 illustrated in FIG. 20 (step S111). The expansion graphic 96 is thus displayed on the display as illustrated in FIG. 21 (step S102). Since an area surrounding the position of the point graphic 93 is expanded into the expansion graphic 96, the user can position the point graphic 93 in a more detailed fashion. As a result, a numerical value may be input with a higher fineness.

The position of the point graphic 93 may not be the position the user intends. The process to be performed in such a case is identical to the specific process of the embodiment 1. The discussion of the process is thus omitted. If the point graphic 93 is moved with the expansion graphic 96 displayed, the expansion graphic 96 also moves in unison with the movement of the point graphic 93 in the embodiment. The expansion graphic 96 may remain stationary as in the embodiment 1. If the user clicks on a “general display” button 42 on the screen of FIG. 21, the expansion graphic image data is erased in response, and the expansion graphic 96 ceases to be displayed as illustrated in FIG. 20 in the same manner as in the embodiment 1.

With the numerical value input device 1 of the embodiment as described above, the user can input the first numerical value in the coordinate space using the GUI without the need to use the numeric keys. Since the numerical value inputting is performed using the expansion graphic 96, a numerical value is easily input with a higher fineness as in the embodiment 1. As illustrated in FIG. 21, the expansion graphic 96 is part of the first axis 91. The approximate position of the point graphic 93 with respect to the whole first axis 91 is easily learned while the expansion graphic 96 is being displayed.

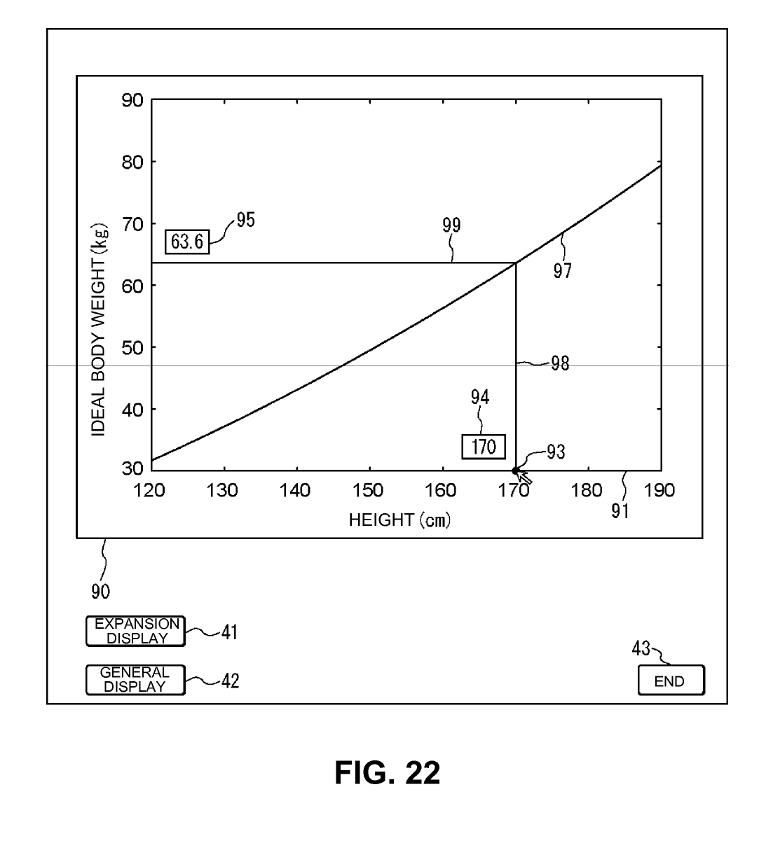

In the embodiment, a graph of the function may be displayed as is. For example, as illustrated in FIG. 22, the image data storage unit 11 stores the coordinate plane image data and the image display unit 13 may display the coordinate plane image data. The coordinate plane image data includes the image data of the first axis 91 as the coordinate axis, and the image data of the second axis (the axis of the ideal body weight in FIG. 22) corresponding to the value given by the function, and of a graph 97 of the function having as a argument the value in the first axis 91. In such a case, the image generation unit 12 generates image data of an auxiliary line 98 drawn from the point graphic 93 to the position of the graph 97 of the function corresponding to the position of the point graphic 93 and image data of an auxiliary line 99 drawn from the position in the graph 97 of the function to a position in the second axis corresponding to the value given by the function calculated by the calculation unit 18. The image display unit 13 may then display the image data of these graphics.

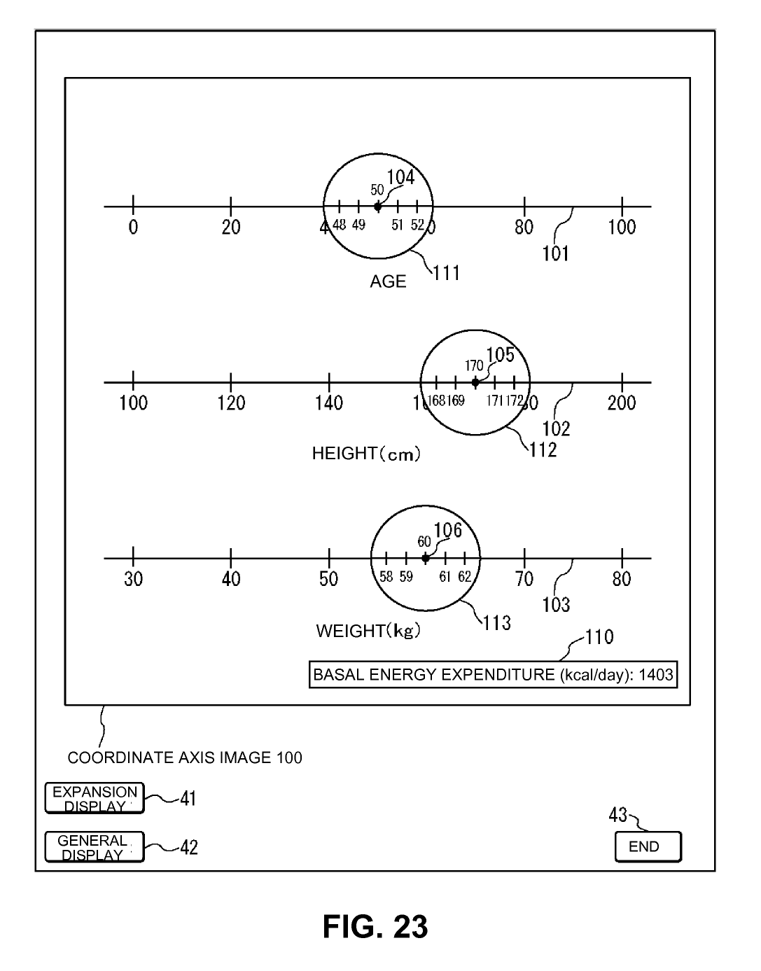

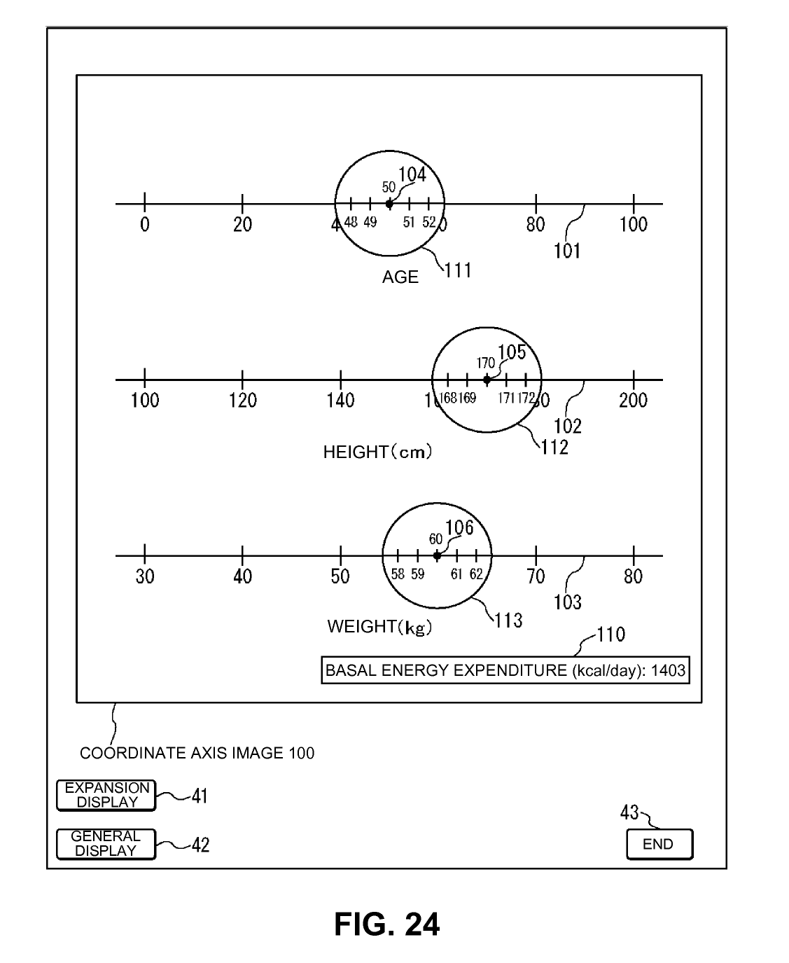

One argument described in the embodiment may be input by a plurality of times to input a plurality of arguments. For example, the values of height, body weight, and age described with reference to the embodiment 2 may be input on a per argument basis. In such a case, first through third axes 101-103 are separately displayed as illustrated in FIG. 23, and an argument, such as height, is input on a per axis basis. In such a case, expansion graphics 111-113 are displayed on a per axis basis as illustrated in FIG. 24. With the expansion graphics 111-113 displayed, the user can input a numerical value with a high fineness.

The image data storage unit 11 in the numerical value input device 1 may store as the coordinate axis image data the image data of each of first through N-th coordinate axes (N is an integer of 2 or higher). The image generation unit 12 may generate as the point graphic image data the image data of the point graphic serving as a graphic denoting a position in each coordinate axis, and as the expansion graphic image data the image data of the expansion graphic serving as part of each coordinate axis and an expansion area of the area including the position of the point graphic. The image generation unit 12 may generate the point graphic image data and the expansion graphic image data on a per coordinate axis basis as illustrated in FIGS. 23 and 24. FIG. 24 illustrates the expansion graphics 111-113 displayed on all the axes. Alternatively, the expansion graphics 111-113 may be displayed or erased on a per axis basis. In such a case, the image generation unit 12 generates the expansion graphic image data on a per axis basis. The image display unit 13 may display the coordinate axis image data read from the image data storage unit 11, and the point graphic image data and the expansion graphic image data, generated by the image generation unit 12. The numerical value acquiring unit 15 may acquire the first through N-th numerical values in the first through N-th axes corresponding to the position of the point graphic. The output unit 16 may output the first through N-th numerical values acquired by the numerical value acquiring unit 15. The image generation unit 12 may generate the point graphic image data corresponding to the position specified by the instruction received by the instruction receiving unit 14 that receives the instruction specifying the position of the point graphic. The image generation unit 12 may generate as first through N-th numerical value image data the image data of the first through N-th numerical values acquired by the numerical value acquiring unit 15, and the image display unit 13 may display these pieces of numerical value image data. The numerical value input device 1 may include the calculation unit 18 that calculates the values given by the predetermined function. The predetermined function has as arguments the first through N-th numerical values acquired by the numerical value acquiring unit 15. The image generation unit 12 generates as the function calculation result image data the image data of the value given by the predetermined function calculated by the calculation unit 18, and the image display unit 13 may display the function calculation result image data. As in each of the above-described embodiments, the image generation unit 12 may generate the expansion graphic image data with the display position thereof changed in response to the position of the point graphic, and if the position in each coordinate axis corresponding to the point graphic falls within the expansion area of the expansion graphic, change of the position of the expansion graphic is not necessary.

The point graphic image data is generated on a per axis basis here. In other words, the numerical values are input individually on a per axis basis as illustrated in FIG. 23. The numerical values may not be input individually. For example, as illustrated in FIGS. 11, 18, and 19, the image data storage unit 11 may store as coordinate space image data as image data of an N-dimensional coordinate space (coordinate plane if N=2) including the coordinate axis image data of the first through N-th axes, and the image display unit 13 may display the coordinate space image data read from the image data storage unit 11. In such a case, a plurality of arguments are input using a single point graphic. As illustrated in FIG. 11, the coordinate space image data may be the image data of a coordinate space that is partitioned into a plurality of regions in response to the values given by the predetermined function with the first through N-th numerical values serving as the arguments.

Even if the numerical values are input on a per axis basis as illustrated in FIG. 23, the coordinate space may be constituted of a plurality of coordinate axes as illustrated in FIG. 15.

According to the embodiments, the numerical value image data (for example, the first and second numerical value image data, the first through third numerical value image data and the like) and the function calculation result image data are generated and displayed. Not all these pieces of data may be generated and displayed. For example, only the function calculation result image data may be generated and displayed. Only the numerical value image data may be generated and displayed. None of the numerical value image data and the function calculation result image data may be generated.

In the embodiments, the coordinate axis image data, the coordinate plane image data, and the coordinate space image data are partitioned into a plurality of regions in response to the value given by the predetermined function. The number of regions is not important. For example, the data may be partitioned into three regions as described with reference to the specific example of the embodiment 1. The data may be partitioned into two regions as described with reference to the specific examples of the embodiments 2 and 3. The data may be partitioned into regions of a different number.

In the embodiments, the coordinate axis image data, the coordinate plane image data, and the coordinate space image data are partitioned into a plurality of regions in response to the value given by the predetermined function. The data may not be partitioned at all. More specifically, the coordinate axis image data, the coordinate plane image data, and the coordinate space image data may not partitioned into a plurality of regions in response to the value given by the predetermined function.

In the embodiments, the three dimensional inputting operation (the inputting of three arguments) is divided into a two-dimensional inputting operation and a one-dimensional inputting operation, or three one-dimensional inputting operations are performed. A four or more dimensional inputting operation (the inputting of four arguments) may be performed through two-dimensional inputting operations or through one-dimensional inputting operations. More specifically, if an M dimensional inputting operation (M is an integer of 3 or higher) is performed, two-dimensional inputting operation may be repeated by a (2×a=M). Alternatively, a single dimensional inputting operation may be repeated by b and a two-dimensional inputting operation may be repeated by c (b+2×c=M). In the case of a two-dimensional inputting operation, a one-dimensional inputting operation may be performed twice.

The numerical value input device 1 is standalone in the discussion of each of the embodiments. The numerical value input device 1 may be a standalone apparatus or a server apparatus in a server-client system. In the latter case, a receiving unit and an output unit may receive an input and may output information via a communication line.

Each process or each function may be centralized-processed by a single apparatus or a single system in each of the embodiments. Alternatively, each process or each function may be decentralized-processed by a plurality of apparatuses or a plurality of systems.

In each of the embodiments, information related to the process performed by each element of the device may be stored on the unillustrated recording medium temporarily or for a long-term period even if the storage of the information related to the process is not expressly described in the above discussion. For example, the information related to the process may include information registered, acquired, selected, generated, transmitted or received by each element, and information such as a threshold value, equation, and addresses used in the process of each element. The storage of the information onto the unillustrated recording medium may be the storage of the information on each element or an unillustrated storage unit. The reading of the information from the unillustrated recording medium may be carried out by each element or an unillustrated reading unit.

In each of the embodiments, the information used in each element may be modified as appropriate by the user on condition that the information is modifiable by the user even if such a modification by the user is not expressly described in the above discussion. For example, the information used in each element may include information such as the threshold value, the address, and a variety of set values used in each element. The information used in each element may not be modified. If these pieces of information are modifiable, the modification thereof may be performed by an unillustrated receiving unit receiving a modification instruction from the user, and an unillustrated modifying unit modifying the information in response to the modification instruction. The unillustrated receiving unit for receiving the modification instruction may receive the instruction from an input device, may receive the information transmitted via a communication line, or may receive the information read from a predetermined recording medium.

If at least two elements included in the numerical value input device 1 have a communication device, an input device, and the like in each of the embodiments, the two elements or more elements may be physically integrated into a unitary device or separated as different devices.

In each of the embodiments, each element may be implemented based on dedicated hardware, or software. An element implementable with software may be implemented by executing a program. For example, each element may be implemented by a program executor, such as CPU, which reads a software program from a recording medium such as a hard disk or a semiconductor memory and executes the software program. The software programs implementing the numerical value input device 1 of the embodiment may include the programs described below. The program causes a computer to perform as an image generation unit for generating, as point graphic image data, image data of a point graphic indicating a position on a coordinate plane of coordinate plane image data, and as expansion graphic image data, image data of an expansion graphic into which a segment being part of the coordinate plane and including the position of the point graphic is expanded, the coordinate plane image data stored on an image data storage unit as image data of the coordinate plane having a first axis and a second axis, an image display unit for displaying the coordinate plane image data read from the image data storage unit, and the point graphic image data and the expansion graphic image data, generated by the image generation unit, an instruction receiving unit for receiving an instruction specifying the position of the point graphic displayed by the image display unit, a numerical value acquiring unit for acquiring first and second numerical values, the first and second numerical values being respectively first and second axis values corresponding to the position of the point graphic on the coordinate plane, and an output unit for outputting the first and second numerical values acquired by the numerical value acquiring unit. The image generation unit generates the point graphic image data corresponding to the position specified by the instruction received by the instruction receiving unit.

The software program implementing the numerical value input device 1 of each of the embodiments includes a program. The program causes a computer to perform as an image generation unit for generating, as point graphic image data, image data of a point graphic indicating a position on a coordinate plane of coordinate plane image data and in a coordinate axis of coordinate axis image data, and as expansion graphic image data, image data of an expansion graphic into which a segment being part of the coordinate plane and including the position of the point graphic is expanded, the coordinate plane image data stored on an image data storage unit as image data of the coordinate plane having a first axis and a second axis, and the coordinate axis image data stored on the image data storage unit as image data of the coordinate axis as a third axis, an image display unit for displaying the coordinate plane image data and the coordinate axis image data, read from the image data storage unit, and the point graphic image data and the expansion graphic image data, generated by the image generation unit, an instruction receiving unit for receiving an instruction specifying the position of the point graphic displayed by the image display unit, a numerical value acquiring unit for acquiring as a third numerical value a third axis value in the third axis corresponding to the position of the point graphic, and first and second numerical values, the first and second numerical values being respectively first and second axis values corresponding to the position of the point graphic on the coordinate plane, and an output unit for outputting the first through third numerical values acquired by the numerical value acquiring unit. The image generation unit generates the point graphic image data corresponding to the position specified by the instruction received by the instruction receiving unit.

The software program implementing the numerical value input device 1 of each of the embodiments includes a program. The program causes a computer to perform as an image generation unit for generating, as point graphic image data, image data of a point graphic indicating a position in a coordinate axis of coordinate axis image data, and as expansion graphic image data, image data of an expansion graphic into which a segment being part of the coordinate axis and including the position of the point graphic is expanded, the coordinate axis image data stored on an image data storage unit as image data of the coordinate axis, an image display unit for displaying the coordinate axis image data read from the image data storage unit, and the point graphic image data and the expansion graphic image data, generated by the image generation unit, an instruction receiving unit for receiving an instruction specifying the position of the point graphic displayed by the image display unit, a numerical value acquiring unit for acquiring a numerical value corresponding to the position of the point graphic in the coordinate axis, and an output unit for outputting the numerical value acquired by the numerical value acquiring unit. The image generation unit generates the point graphic image data corresponding to the position specified by the instruction received by the instruction receiving unit.

The software program implementing the numerical value input device 1 of each of the embodiments includes a program. The program causes a computer to perform as an image generation unit for generating, as point graphic image data, image data of a point graphic indicating a position in each of first through N-th coordinate axes (N being an integer of 2 or larger) of coordinate axis image data, and as expansion graphic image data, image data of an expansion graphic into which a segment being part of each of the coordinate axes and including the position of the point graphic is expanded, the coordinate axis image data stored on an image data storage unit as image data of the first through N-th coordinate axes, an image display unit for displaying the coordinate axis image data read from the image data storage unit, and the point graphic image data and the expansion graphic image data, generated by the image generation unit, an instruction receiving unit for receiving an instruction specifying the position of the point graphic displayed by the image display unit, a numerical value acquiring unit for acquiring first through N-th numerical values, the first through N-th numerical values respective being first through N-th axis values corresponding to the position of the point graphic, and an output unit for outputting the first through N-th numerical values acquired by the numerical value acquiring unit. The image generation unit generates the point graphic image data corresponding to the position specified by the instruction received by the instruction receiving unit.

The functions performed by the program do not include any function that is performed by hardware only. For example, the functions performed by the program do not include the functions that are performed by hardware only, such as a modem and an interface card in a receiving unit receiving information, and in a display unit displaying information, and the like.

The program may be executed after being downloaded from a server and the like, or after being read from a predetermined recording medium (such as an optical disk like a CD-ROM, or a magnetic disk, or a semiconductor memory). The program may be the one included in a program product.

The program may be executed by a single computer or a plurality of computers. More specifically, the program may be executed through centralized processing or decentralized processing.

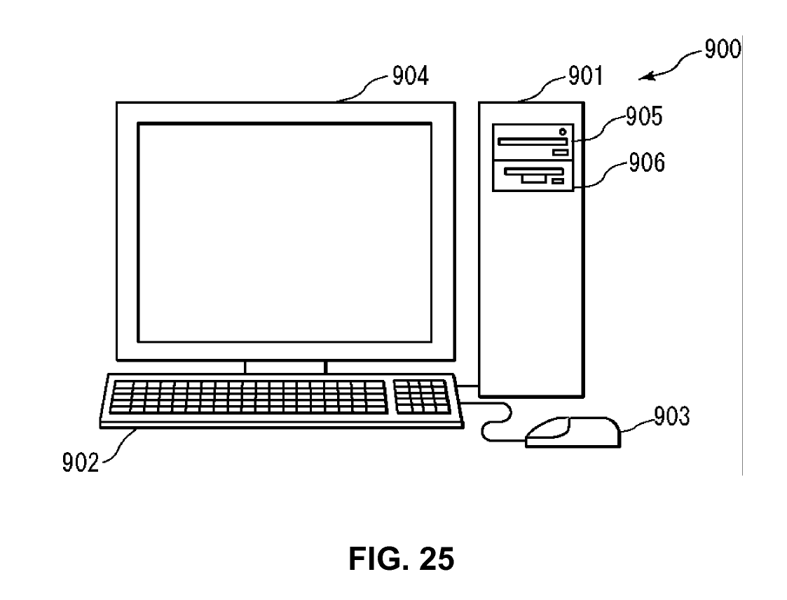

FIG. 25 is a diagrammatic view illustrating the appearance of the computer that implements the numerical value input devices 1 of the embodiments by executing the program. The embodiments may be implemented by computer hardware and a software program running on the computer hardware.

A computer system 900 of FIG. 25 includes a computer 901 including a CD-ROM (Compact Disk Read Only Memory) drive 905, and an FD (Floppy (registered trademark) Disk) drive 906, a keyboard 902, a mouse 903, and a monitor 904.

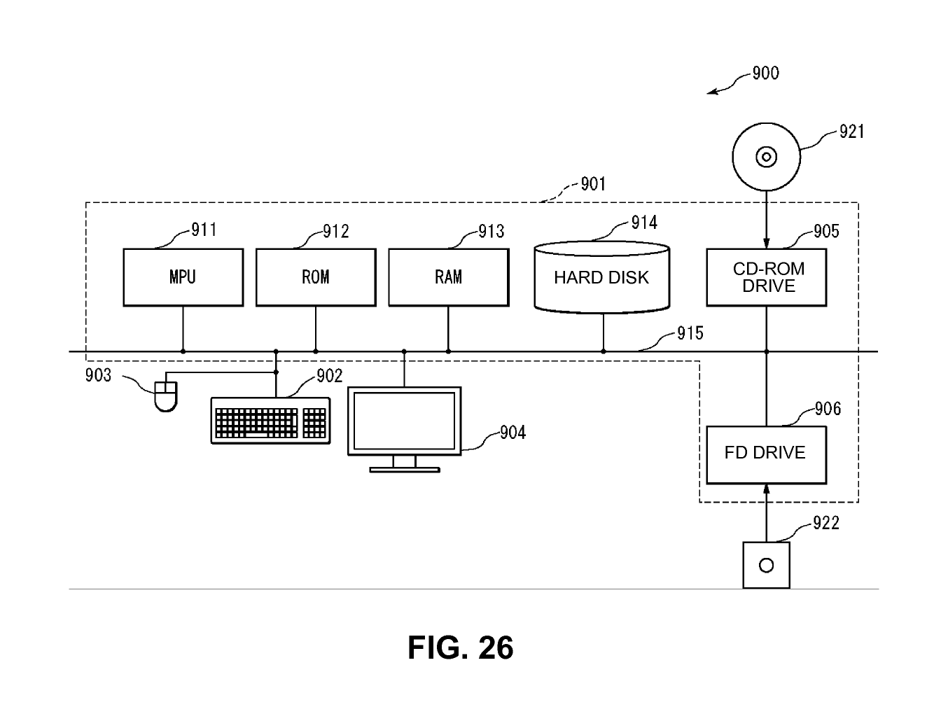

FIG. 26 illustrates an internal structure of the computer system 900. As illustrated in FIG. 26, the computer 901 includes, in addition to the CD-ROM drive 905, and the FD drive 906, an MPU (Micro Processing Unit) 911, a ROM 912 storing programs such as a bootup program, a RAM (Random Access Memory) 913 connected to the MPU 911, temporarily storing an instruction of an application program and temporarily providing a memory space, a hard disk 914 storing the application program, a system program, and data, and a bus 915 interconnecting the MPU 911, the ROM 912, and the like. The computer 901 may include an unillustrated network card providing connection to a LAN.

The program causing the computer system 900 to perform the function of the numerical value input device 1 of the embodiments may be stored on one of the CD-ROM 921 and the FD 922, which are respectively loaded onto the CD-ROM drive 905 and the FD drive 906. The program is thus transferred to the hard disk 914. Alternatively, the program may be transmitted to the computer 901 via an unillustrated network, and then stored onto the hard disk 914. The program, when executed, is loaded onto the RAM 913. The program may be loaded from the CD-ROM 921 or the FD 922, or directly via the network.

The program may not necessarily include an operating system (OS) causing the computer 901 to execute the function of the numerical value input device 1 of the embodiment, a third-party program, and the like. The program may include only an instruction that calls an appropriate function (module) in a controlled manner, and achieves desired results. The operation of the computer system 900 is known, and the detailed discussion thereof is omitted herein.

The invention is not limited to the embodiments, and a variety of modifications are possible and fall within the scope of the invention.

### INDUSTRIAL APPLICABILITY

The numerical value input device of the invention provides the advantage that the numerical value is input by specifying the position of the point graphic. For example, the numerical value input device is useful as a device with which the user inputs a numerical value while viewing a display and the like. An application example of the numerical value input device of the invention is the calculation of BMI as described above. A large number of people have calculated BMI through calculation by writing, on a desk calculating machine, or by inputting text in a website. The numerical value input device allows the user to calculate BMI easily and to understand the meaning of BMI. The numerical value input device can thus contribute to the spreading of the concept of BMI and help promote health of people. Another application example of the numerical value input device is the calculation of basal energy expenditure. Health and medical service personnel has calculated basal energy expenditure so far through calculation by writing, on a desk calculating machine, or by inputting text in a website. The numerical value input device allows the user to calculate basal energy expenditure easily and to understand the meaning of basal energy expenditure. The numerical value input device can thus contribute to the spreading of the concept of basal energy expenditure and help promote health of people. The health and medical field has a large number of other indexes easily calculated in a similar fashion. In fields other than the health and medical field, the numerical value input device is expected to provide a large number of people and directly related persons with an easy method in a variety of calculations. For example, the numerical value input device is expected to find socially useful applications, for example, calculation of text, social insurance, and interests on debt loan. The numerical value input device of the invention is expected to contribute to improvement in people's living.

1-8. (canceled)

9. A numerical value input device comprising:
an image data storage unit for storing, as coordinate axis image data, image data of a coordinate axis;
an image generation unit for generating, as point graphic image data, image data of a point graphic indicating a position in the coordinate axis, and as expansion graphic image data, image data of an expansion graphic into which a segment being part of the coordinate axis and including the position of the point graphic is expanded;
an image display unit for displaying the coordinate axis image data read from the image data storage unit, and the point graphic image data and the expansion graphic image data, generated by the image generation unit;
an instruction receiving unit for receiving an instruction specifying the position of the point graphic displayed by the image display unit;
a numerical value acquiring unit for acquiring a numerical value corresponding to the position of the point graphic in the coordinate axis; and
an output unit for outputting the numerical value acquired by the numerical value acquiring unit,
wherein the image generation unit generates the point graphic image data corresponding to the position specified by the instruction received by the instruction receiving unit.

10. The numerical value input device according to claim 9, wherein the coordinate axis image data is image data of the coordinate axis that is partitioned into a plurality of regions in response to a value given by a predetermined function having as an argument the value in the coordinate axis.

11. The numerical value input device according to claim 9, further comprising a calculation unit for calculating the value given by the predetermined function using as the argument the numerical value acquired by the numerical value acquiring unit,
wherein the image generation unit generates, as numerical value image data, image data of the numerical value acquired by the numerical value acquiring unit and as function calculation result image data, image data of the value given by the function calculated by the calculation unit; and
wherein the image display unit displays the numerical value image data, and the function calculation result image data.

12. The numerical value input device according to claim 9, wherein the image generation unit generates the expansion graphic image data with a display position thereof changed in response to the position of the point graphic.

13. The numerical value input device according to claim 9, wherein the image generation unit does not change the position of the expansion graphic if the position of the point graphic is within an expansion area of the expansion graphic.

14. A numerical value input device comprising:
an image data storage unit for storing, as coordinate axis image data, image data of first through N-th (N being an integer of 2 or larger) coordinate axes;
an image generation unit for generating, as point graphic image data, image data of a point graphic indicating a position in each of the coordinate axes, and as expansion graphic image data, image data of an expansion graphic into which a segment being part of each of the coordinate axes and including the position of the point graphic is expanded;
an image display unit for displaying the coordinate axis image data read from the image data storage unit, and the point graphic image data and the expansion graphic image data, generated by the image generation unit;
an instruction receiving unit for receiving an instruction specifying the position of the point graphic displayed by the image display unit;
a numerical value acquiring unit for acquiring first through N-th numerical values, the first through N-th numerical values respectively being first through N-th axis values corresponding to the position of the point graphic; and
an output unit for outputting the first through N-th numerical values acquired by the numerical value acquiring unit,
wherein the image generation unit generates the point graphic image data corresponding to the position specified by the instruction received by the instruction receiving unit.

15. The numerical value input device according to claim 14, wherein the image generation unit generates the point graphic image data and the expansion graphic image data on a per coordinate axis basis.

16. The numerical value input device according to claim 14, wherein the image data storage unit stores, as coordinate space image data, image data of an N-dimensional coordinate space including coordinate space image data of the first through N-th axes, and
wherein the image display unit displays the coordinate space image data read from the image data storage unit.

17. The numerical value input device according to claim 16, wherein the coordinate space image data is image data of the coordinate space that is partitioned into a plurality of regions in response to a value given by a predetermined function having as arguments the first through N-th numerical values.

18. The numerical value input device according to claim 14, further comprising a calculation unit for calculating the value given by the predetermined function using as the arguments the first through N-th numerical values acquired by the numerical value acquiring unit,
wherein the image generation unit generates, as first through N-th numerical value image data, image data of the first through N-th numerical values acquired by the numerical value acquiring unit and as function calculation result image data, image data of the value given by the function calculated by the calculation unit; and
wherein the image display unit displays the first through N-th numerical value image data, and the function calculation result image data.

19. The numerical value input device according to claim 14, wherein the image generation unit generates the expansion graphic image data with a display position thereof changed in response to the position of the point graphic.

20. The numerical value input device according to claim 14, wherein the image generation unit does not change the position of the expansion graphic if the position of the point graphic in each of the coordinate axes is within an expansion area of the expansion graphic.

21-26. (canceled)

27. A numerical value input method performed using an image data storage unit storing, as coordinate axis image data, image data of a coordinate axis, an image generation unit, an image display unit, an instruction receiving unit, a numerical value acquiring unit, and an output unit, the numerical value input method comprising:
a first image generation step of the image generation unit for generating, as point graphic image data, image data of a point graphic indicating a position in the coordinate axis, and as expansion graphic image data, image data of an expansion graphic into which a segment being part of the coordinate axis and including the position of the point graphic is expanded;
a first image display step of the image display unit for displaying the coordinate axis image data read from the image data storage unit, and the point graphic image data and the expansion graphic image data, generated in the first image generation step;
an instruction receiving step of the instruction receiving unit for receiving an instruction specifying the position of the point graphic displayed in the first image display step;
a second image generation step of the image generation unit for generating point graphic image data corresponding to the position specified by the instruction received in the instruction receiving step;
a second image display step of the image display unit for displaying the point graphic image data generated in the second image generation step;
a numerical value acquiring step of the numerical value acquiring unit for acquiring a numerical value corresponding to the position of the point graphic in the coordinate axis; and
an output step of the output unit for outputting the numerical value acquired in the numerical value acquiring step.

28. A numerical value input method performed using an image data storage unit storing, as coordinate axis image data, image data of each of first through N-th (N being an integer of 2 or larger) coordinate axes, an image generation unit, an image display unit, an instruction receiving unit, a numerical value acquiring unit, and an output unit, the numerical value input method comprising:
a first image generation step of the image generation unit for generating, as point graphic image data, image data of a point graphic indicating a position in each of the coordinate axes, and as expansion graphic image data, image data of an expansion graphic into which a segment being part of each of the coordinate axes and including the position of the point graphic is expanded;
a first image display step of the image display unit for displaying the coordinate axis image data read from the image data storage unit, and the point graphic image data and the expansion graphic image data, generated in the first image generation step;
an instruction receiving step of the instruction receiving unit for receiving an instruction specifying the position of the point graphic displayed in the first image display step;
a second image generation step of the image generation unit for generating point graphic image data corresponding to the position specified by the instruction received in the instruction receiving step;
a second image display step of the image display unit for displaying the point graphic image data generated in the second image generation step;
a numerical value acquiring step of the numerical value acquiring unit for acquiring first through N-th numerical values, the first through N-th numerical values being first through N-th axis values corresponding to the position of the point graphic; and
an output step of the output unit for outputting the first through N-th numerical values acquired in the numerical value acquiring step.
